(19) United States
(12) Patent Application Publication
(10) Pub. No.: US 2026/0105639 A1
(43) Pub. Date: Apr. 16, 2026

(54) ENCODER, DECODER, AND IMAGE PROCESSING SYSTEM

(71) Applicant: SAMSUNG ELECTRONICS CO., LTD., Suwon-si (KR)

(72) Inventors: Wonseok Lee, Suwon-si (KR); Jungchan Kyoung, Suwon-si (KR); Youngjin Kim, Suwon-si (KR); Youngsung Cho, Suwon-si (KR)

(73) Assignee: SAMSUNG ELECTRONICS CO., LTD., Suwon-si (KR)

(21) Appl. No.: 19/354,341

(22) Filed: Oct. 9, 2025

(30) Foreign Application Priority Data
Dec. 2, 2024 (KR) 10-2024-0176724
Oct. 14, 2024 (KR) 10-2024-0139839

(51) Int. Cl. G06T 9/00; G06F 9/30; G06T 1/20

(52) U.S. Cl. CPC G06T 9/00; G06F 9/30098; G06T 1/20

(57) ABSTRACT

An encoder for compressing image data generated by an image sensor, including: a bit-depth control circuit configured to: generate first image data based on a first plurality of bits extracted from the image data according to at least one encoding scheme, and generate second image data, based on a second plurality of bits corresponding to remaining image data different from the first image data from among the image data; an encoding circuit configured to compress the first image data to generate partial compressed data; a register configured to store the second image data; and a packing circuit configured to: pack the second image data into the partial compressed data to generate compressed data, and output the compressed data.

### CROSS-REFERENCE TO RELATED APPLICATION

This application is based on and claims priority under 35 U.S.C. §119 to Korean Patent Application No. 10-2024-0139839, filed on Oct. 14, 2024, and Korean Patent Application No. 10-2024-0176724, filed on Dec. 2, 2024, in the Korean Intellectual Property Office, the disclosures of which are incorporated by reference herein in their entireties.

### BACKGROUND

The disclosure relates to an encoder, a decoder and an image processing system, for compressing and decompressing image data.

Recently, as the demand for high-quality and high-definition photos and videos has increased, the number of sensing pixels in the pixel array of image sensors is increasing. Accordingly, the bit depths of image data generated from image sensors are also increasing. Image data may be transmitted to an image processing device and may be compressed by an encoder to increase transmission efficiency. The image processing device may perform various forms of image processing after decompressing compressed image data by using a decoder. As high dynamic range (HDR) technology develops, an encoder, a decoder, and an image processing system including the same are required to efficiently process high bit-depth image data.

### SUMMARY

Provided is an encoder, a decoder, and an image processing system for efficiently processing image data (e.g., HDR image data) with a high bit depth.

Additional aspects will be set forth in part in the description which follows and, in part, will be apparent from the description, or may be learned by practice of the presented embodiments.

In accordance with an aspect of the disclosure, an encoder for compressing image data generated by an image sensor includes: a bit-depth control circuit configured to: generate first image data based on a first plurality of bits extracted from the image data according to at least one encoding scheme, and generate second image data, based on a second plurality of bits corresponding to remaining image data different from the first image data from among the image data; an encoding circuit configured to compress the first image data to generate partial compressed data; a register configured to store the second image data; and a packing circuit configured to: pack the second image data into the partial compressed data to generate compressed data, and output the compressed data.

In accordance with an aspect of the disclosure, a decoder for decompressing compressed data includes: a bit-depth control circuit configured to separate the compressed data into partial compressed data and remaining compressed data according to at least one decoding scheme; a register configured to store the remaining compressed data; a decoding circuit configured to decompress the partial compressed data to generate partial decompressed data; and a dithering circuit configured to: generate random data, pack a portion of the remaining compressed data into the partial decompressed data, based on the at least one decoding scheme, to generate packing data, and pack the random data into the packing data to generate decompressed data.

In accordance with an aspect of the disclosure, an image processing system includes: an image sensor configured to sense a received optical signal in order to generate image data; an encoder configured to sequentially compress a plurality of pixel groups included in the image data to generate a plurality of bitstreams; and a decoder configured to decompress the plurality of bitstreams to restore the image data, wherein the encoder is further configured to: generate first image data and second image data, based on the image data, according to at least one encoding scheme; compress the first image data to generate partial compressed data; and pack the second image data into the partial compressed data to generate the plurality of bitstreams.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIGS. 1A and 1B are diagrams illustrating a compression operation of high dynamic range (HDR) image data in an image processing system, according to an embodiment;

FIG. 2A is a block diagram of an image processing system according to an embodiment and FIG. 2B is a diagram of a pixel array and image data applied to an image sensor module, according to an embodiment;

FIG. 3 is a block diagram of an encoder according to an embodiment;

FIG. 4 is a block diagram of a decoder according to an embodiment;

FIG. 5 is a diagram illustrating an operation of an encoder according to an embodiment;

FIG. 6 is a diagram illustrating an operation of a decoder according to an embodiment;

FIG. 7 is a diagram illustrating an operation of an encoder according to an embodiment;

FIG. 8 is a diagram illustrating an operation of a decoder according to an embodiment;

FIG. 9 is a diagram illustrating an operation of an encoder according to an embodiment;

FIG. 10 is a diagram illustrating an operation of a decoder according to an embodiment;

FIG. 11 is a block diagram of an electronic device including a multi-camera module, according to an embodiment;

FIG. 12 is a detailed block diagram of a camera module according to an embodiment; and

FIG. 13 is a schematic block diagram of an electronic device according to an embodiment.

### DETAILED DESCRIPTION OF THE EMBODIMENTS

Hereinafter, embodiments are described in detail with reference to the accompanying drawings. Although some embodiments are illustrated in the drawings and detailed description, this is not intended to limit the disclosure to these particular examples. For example, it should be obvious to those skilled in the art that the embodiments described below may be modified in various ways.

As used herein, expressions such as “at least one of,” when preceding a list of elements, modify the entire list of elements and do not modify the individual elements of the list. For example, the expression, "at least one of A, B, and C," should be understood as including only A, only B, only C, both A and B, both A and C, both B and C, or all of A, B, and C.

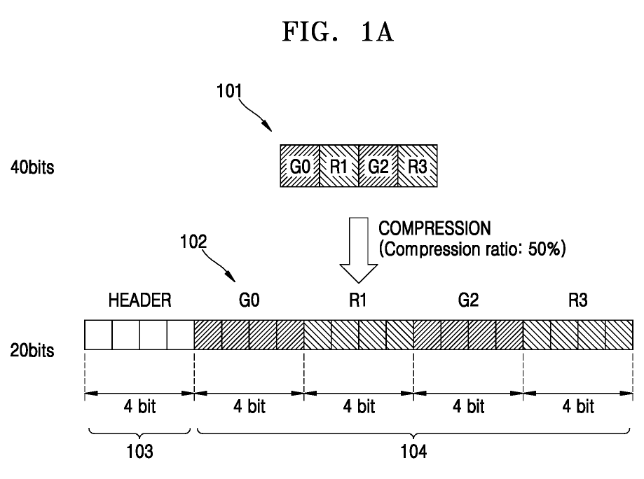

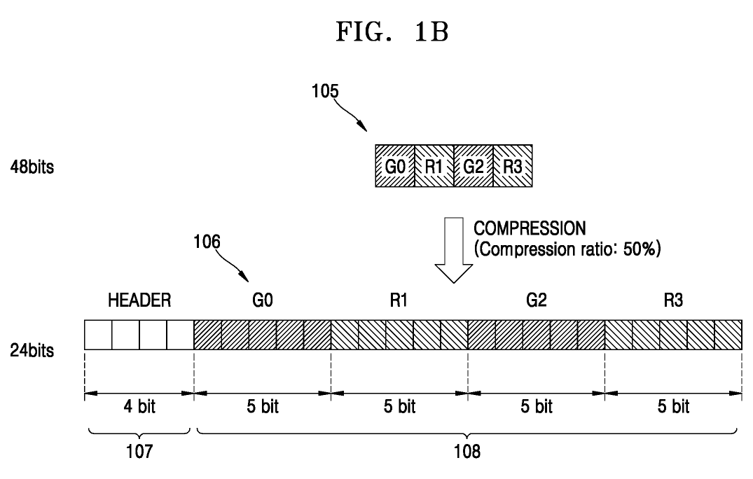

FIGS. 1A and 1B are diagrams illustrating a compression operation for high dynamic range (HDR) image data in an image processing system, according to an embodiment.

Referring to FIG. 1A, an encoder of an image processing system, according to a first comparative example, may generate compressed data 102, that may have a size of, for example, 20 bits, by compressing image data 101, that may have a size of, for example, 40 bits, and that may include pixel values of a plurality of pixels (e.g., pixel G0, pixel R1, pixel G2, and pixel R3) at a compression ratio of 50%. For example, the compressed data 102 (e.g., 20 bits) may include a header 103 that may have a size of, for example, 4 bits, and a payload 104 that may have a size of, for example, 16 bits. The header 103 may include information about a compression method of the image data 101, and the payload 104 may include information (which may be referred to as pixel data) about compressed pixel values of the plurality of pixels (e.g., pixel G0, pixel R1, pixel G2, and pixel R3). According to embodiments, the compression method may refer to a type of compression used to generate or obtain the compressed data, and may also be referred to as a compression process, a compression scheme, or a compression technique. A space that may have a size of, for example, 4 bits, for storing compressed pixel data may be allocated for each pixel in the payload 104. The bit depth of the image data 101 in FIG. 1A may be 10 bits. For example, each pixel included in the pixel data may have a size of 10 bits, and a decoder according to the first comparative example may perform lossy compression to compress each pixel to have a size of 4 bits, in order to obtain the payload 104 having the size of 16 bits.

Referring to FIG. 1B, an encoder of an image processing system according to a second comparative example may generate compressed data 106 that may have a size of, for example, 24 bits, by compressing image data 105 that may have a size of, for example, 48 bits, including pixel values of a plurality of pixels (e.g., pixel G0, pixel R1, pixel G2, and pixel R3) at a compression ratio of 50%. For example, the compressed data 106 (e.g., 24 bits) may include a header 107 that may have a size of, for example, 4 bits, and a payload 108 that may have a size of, for example, 20 bits. The header 107 may include information about a compression method of the image data, and the payload 108 may include information about compressed pixel values (e.g., pixel data) of a plurality of pixels (e.g., pixel G0, pixel R1, pixel G2, and pixel R3). A space, that may have a size of, for example, 5 bits, for storing compressed pixel data may be allocated for each pixel in the payload. The bit depth of the image data 105 in FIG. 1B may be 12 bits. For example, each pixel included in the pixel data may have a size of 10 bits, and a decoder according to the second comparative example may perform lossy compression to compress each pixel to have a size of 5 bits, in order to obtain the payload 108 having the size of 20 bits.

Comparing the first comparative example with the second comparative example, it may be seen that the space of the payload of the compressed data CDT only increases by 1 bit (e.g., from 4 bits to 5 bits), even though the size of the pixel data for each pixel increases by 2 bits (e.g., from 10 bits to 12 bits). In other words, although the bit depth increases by 2 bits and the amount of information (e.g., pixel code value) of the representable pixel data increases by a factor of 4 (e.g, quadruples), the space of the payload for storing the same only increases by a factor of 2 (e.g., doubles), causing the encoder according to a comparative example to perform lossy compression with greater image quality loss. Moreover, when image data having a higher bit depth (e.g., 14 bits) is compressed with high dynamic range (HDR) technology, the image quality loss and compression efficiency reduction due to the above-described problem may deteriorate.

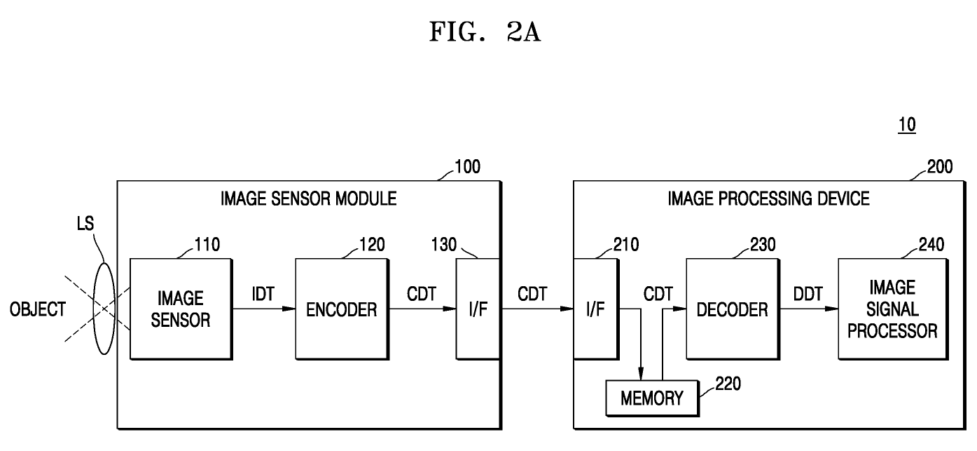

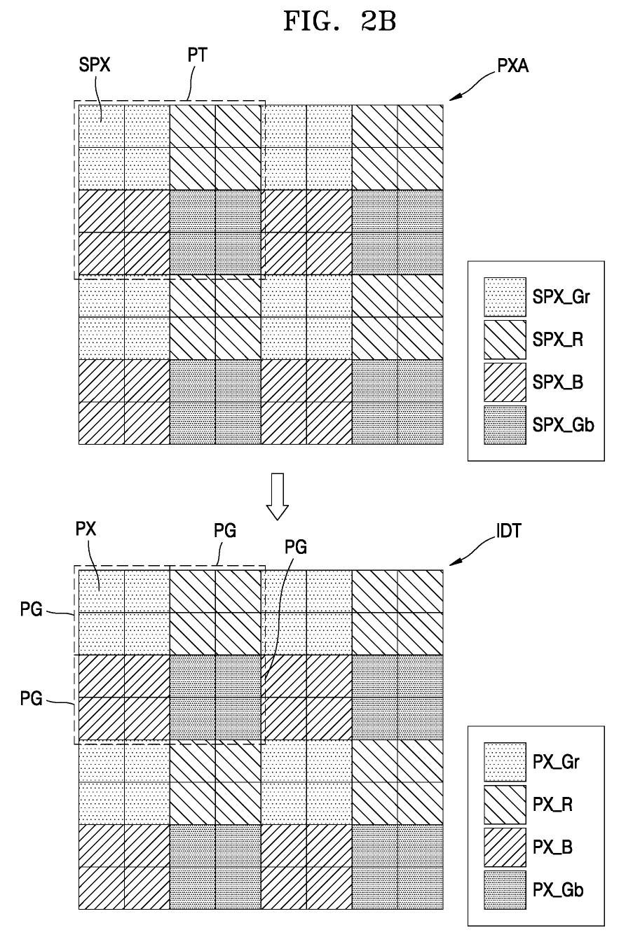

Accordingly, embodiments may relate to an encoder, a decoder, and an image processing system including the same, that may efficiently compress and/or decompress image data having a high bit depth, without excessive configuration changes (e.g., adding new logic or increasing the size of existing logic). Detailed descriptions of examples thereof are given below with reference to FIGS. 2A-13.

FIG. 2A is a block diagram of an image processing system according to an embodiment and FIG. 2B is a diagram of a pixel array and image data applied to an image sensor module, according to an embodiment.

An image processing system 10 may sense, generate, or otherwise obtain an image of an object, process or store the image in memory, and store the processed image in the memory. According to an embodiment, the image processing system 10 may be implemented as at least one of a digital camera, a digital camcorder, a mobile phone, or a tablet computer, and a portable electronic device. The portable electronic device may include at least one of a laptop computer, a mobile phone, a smartphone, a tablet personal computer (PC), a personal digital assistant (PDA), an enterprise digital assistant (EDA), a digital still camera, a digital video camera, an audio device, a portable multimedia player (PMP), a personal navigation device (PND), an MP3 player, a handheld game console, an e-book, a wearable device, and the like. In addition, the image processing system 10 may be mounted as a component in an electronic device, such as at least one of a drone or an advanced driver assistance system (ADAS), or in a vehicle, furniture, a manufacturing facility, a door, various measurement devices, and the like.

Referring to FIG. 2A, the image processing system 10 may include an image sensor module 100 and an image processing device 200. In an embodiment, the image sensor module 100 may include an image sensor 110, an encoder 120, and an interface 130. In an embodiment, the image sensor module 100 may be implemented as a plurality of semiconductor chips. For example, a pixel array of the image sensor 110 (e.g., the pixel array PXA illustrated in FIG. 2B) may be integrated into one semiconductor chip. A logic circuit of the image sensor 110, the encoder 120, and the interface 130 may be integrated into another semiconductor chip. A plurality of semiconductor chips may be electrically connected to each other through a connecting member or may be stacked and electrically connected to each other through a through via. However, embodiments are not limited thereto. For example, in some embodiments, the image sensor module 100 may be implemented as one semiconductor chip, or in any number of semiconductor chips.

In an embodiment, the image processing device 200 may include an interface 210, memory 220, a decoder 230, and an image signal processor 240.

The image sensor module 100 may photograph or otherwise obtain an image of an external object, and generate image data IDT. The image sensor module 100 may include the image sensor 110 capable of converting an optical signal of the object incident through a lens LS into an electrical signal.

The image sensor 110 may include a pixel array (e.g., the pixel array PXA illustrated in FIG. 2B) in which a plurality of sensing pixels (e.g., sensing pixels SPX illustrated in FIG. 2B) may be two-dimensionally arranged, and may output the image data IDT including a plurality of pixel values corresponding to the plurality of sensing pixels SPX of the pixel array PXA, respectively.

The pixel array PXA may include a plurality of row lines, a plurality of column lines, and a plurality of sensing pixels SPX each connected to the row lines and the column lines and arranged in a matrix form.

Each of the plurality of sensing pixels SPX of the pixel array PXA may detect or sense an optical signal of at least one color of a plurality of reference colors. For example, the plurality of reference colors may include red, green, and blue, or red, green, blue and white, and may include other colors. For example, the plurality of reference colors may include cyan, yellow, green, and magenta. The pixel array PXA may generate pixel signals including information about a reference color of each of the plurality of sensing pixels SPX.

For example, as shown in FIG. 2B, the pixel array PXA may include a red sensing pixel SPX_R, a blue sensing pixel SPX _B, and two green sensing pixels SPX_Gr and SPX_Gb. A green sensing pixel arranged in the same row as the red sensing pixel SPX_R may be referred to as the first green sensing pixel SPX_Gr and a green sensing pixel arranged in the same row as the blue sensing pixel SPX_B may be referred to the second green sensing pixel SPX_Gb.

Red sensing pixels SPX_R, blue sensing pixels SPX_B, first green sensing pixels SPX_Gr, and second green sensing pixels SPX_Gb may be arranged in a matrix, which may be referred to as a pixel pattern PT. A plurality of pixel patterns PT may be repeatedly arranged in the pixel array PXA.

For example, as shown in FIG. 2B, the pixel pattern PT may include red sensing pixels SPX_R arranged in a 2×2 matrix, blue sensing pixels SPX_B arranged in a 2×2 matrix, first green sensing pixels SPX_Gr arranged in a 2×2 matrix, and second green sensing pixels SPX_Gb arranged in a 2×2 matrix. This pixel pattern PT may be referred to as a tetra pattern. However, embodiments are not limited thereto. For example, in some embodiments, the pixel pattern PT may include a red sensing pixel SPX_R, a blue sensing pixel SPX_B, a first green sensing pixel SPX_Gr, and a second green sensing pixel SPX_Gb, which are arranged in a 2×2 matrix, and may be referred to as a Bayer pattern. As another example, in some embodiments, the pixel pattern PT may include red sensing pixels SPX_R arranged in an n×n matrix (where n is an integer of 3 or greater), blue sensing pixels SPX_B arranged in an n×n matrix, first green sensing pixels SPX_Gr arranged in an n×n matrix, and second green sensing pixels SPX_Gb arranged in an n×n matrix.

The image data IDT may be generated based on pixel signals output from the pixel array PXA. The image data IDT may have a color pattern corresponding to the pixel pattern PT of the pixel array PXA. As an example, when the pixel array PXA has a Bayer pattern, the image data IDT may also have a Bayer pattern. As another example, when the pixel array PXA has a tetra pattern, the image data IDT may have a tetra pattern or a Bayer pattern.

For example, when the pixel array PXA has a tetra pattern, one pixel signal may be output from four sensing pixels SPX of the same color included in the pixel pattern SPX or four pixel signals may be output as the pixel signals are output from the respective four sensing pixels SPX. When one pixel signal is output, the image data IDT may have a Bayer pattern, and when four pixel signals are output, as shown in FIG. 2B, the image data IDT may have a tetra pattern.

The image data IDT may include a red pixel PX_R, a blue pixel PX_B, a first green pixel PX_Gr, and a second green pixel PX_Gb that are repeatedly arranged. The pixel PX of the image data IDT may refer to data corresponding to the sensing pixels SPX of the pixel array PXA, (e.g., pixel data). The red pixel PX_R, the blue pixel PX_B, the first green pixel PX_Gr, and the second green pixel PX_Gb may respectively correspond to the red sensing pixel SPX_R, the blue sensing pixel SPX_B, the first green sensing pixel SPX_Gr, and the second green sensing pixel SPX_Gb of the pixel array PXA.

The image data IDT may include a plurality of pixel groups PG. According to a color pattern of the image data IDT, the pixel groups PG may be set to include a predetermined number of pixels PX arranged sequentially in a matrix or in one direction or to include pixels PX that are adjacent to each other and correspond to the same reference color.

For example, as shown in FIG. 2B, when the image data IDT has a tetra pattern, a pixel group PG may be set to include four pixels PX that are adjacent to each other and correspond to the same reference color (e.g., red, blue, or green). As another example, when the image data IDT has a Bayer pattern, the pixel group PG may be set to include a predetermined number (e.g., four) of pixels PX arranged in a matrix.

With reference to FIG. 2A, each of the plurality of sensing pixels SPX may include at least one photodetector or photoelectric converter. The photodetector may sense light and convert the sensed light into an electrical signal. For example, the photodetector may include at least one of a photodiode, a phototransistor, a photogate, a pinned photodiode (PPD), and a combination thereof.

Each of the plurality of sensing pixels SPX may include at least one photodetector and a pixel circuit for outputting a pixel signal corresponding to the electrical signal generated by the photodetector. For example, the pixel circuit may have a four-transistor structure including a transfer transistor, a reset transistor, an amplification transistor, and a selection transistor. However, the pixel circuit is not limited thereto. For example, in some embodiments, the pixel circuit may have a one-transistor structure, a three-transistor structure, a four-transistor structure, or a five-transistor structure, or may have a structure in which a plurality of pixels share some transistors. In an embodiment, the pixel circuit may include at least one of a memory and an analog-to-digital converter.

In an embodiment, a plurality of color filters transmitting an optical signal corresponding to a specific wavelength band (e.g., an optical signal corresponding to a specific color) may be disposed on the plurality of pixels to respectively correspond to the plurality of pixels of the pixel array PXA, and at least one photodetector provided in the pixel may convert the optical signal transmitted through the corresponding color filter into an electrical signal. Accordingly, each of the plurality of sensing pixels SPX of the pixel array PXA may output at least one pixel signal for at least one assigned reference color. However, embodiments are not limited thereto. For example, in some embodiments, at least one photodetector provided in the sensing pixel SPX may selectively convert an optical signal in a specific wavelength band of incident light into an electrical signal.

In an embodiment, the image data IDT may include raw image data including a plurality of pixel values obtained by digital-analog conversion of a plurality of pixel signals output from the pixel array PXA or image data obtained by pre-processing of the raw image data.

To improve the data transmission speed, reduce the power consumption due to data transmission, and improve the data storage space efficiency, the image sensor module 100 may compress the image data IDT by using the encoder 120 and transmit the compressed data CDT to the image processing device 200.

The encoder 120 may receive the image data IDT from the image sensor 110, and may compress the image data IDT to generate the compressed data CDT. The compressed data CDT may be implemented in the form of an encoded bitstream. Hereinafter, the encoded bitstream may be referred to as a bitstream. The bitstream may include a compression result and compression information (e.g., mode information indicating a compression method used to obtain the compression result).

The encoder 120 may encode the image data IDT in units of pixel groups PG to generate the compressed data CDT. The encoder 120 may encode one pixel group PG to generate one bitstream and may generate the compressed data CDT based on bitstreams of all the pixel groups PG in the image data IDT. Because the pixel group PG may be compressed by encoding the pixel group PG, according to some embodiments, the encoding may be referred to as compression, and the compression may be referred to as encoding.

The encoder 120 may perform compression based on pixel values corresponding to pixels compressed earlier than the pixel group PG on which compression is to be performed, (e.g., a target pixel group). For example, the encoder 120 may compress a pixel value of a target pixel based on a reference value of at least one reference pixel adjacent to at least one target pixel in the target pixel group. The reference value may be generated based on a pixel value of the reference pixel. For example, the reference value may include a value obtained by compressing and then decompressing the pixel value of the reference pixel.

The pixel value of the target pixel and the pixel value of the reference pixel adjacent thereto may be likely to have similar values. In addition, the pixel values of the target pixels in the target pixel group may be likely to have similar values. Accordingly, the encoder 120 may compress the target pixel group using a compression method referred to as a differential pulse code modulation (DPCM) method that encodes target pixels of the target pixel group based on the difference between the target pixels in the target pixel group and the pixels adjacent thereto, for example, a difference value between the pixel value of the target pixel and the reference value of the reference pixel adjacent thereto or a difference value between the pixel value of the target pixel and the pixel value of another target pixel in the target pixel group. Accordingly, the compression efficiency (or compression ratio) may be increased and data loss due to compression may be reduced.

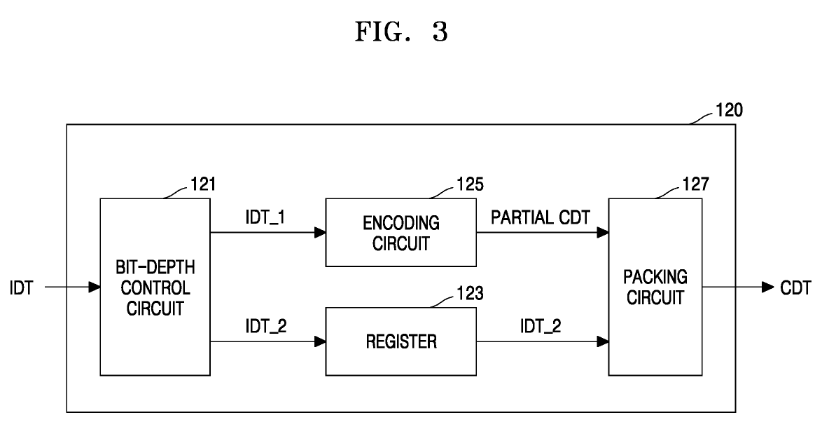

The encoder 120, according to an embodiment, may generate partial compressed data by compressing at least a first portion of image data (e.g., first image data) included in the image data IDT, and may generate the compressed data CDT by packing at least a portion of remaining image data (e.g., second image data) included in the image data IDT, into the partial compressed data. Accordingly, the encoder 120, according to an embodiment, may improve the compression efficiency without excessive deformation of intellectual property (IP) blocks included in the image sensor module 100 (e.g., increase in size of IP blocks or addition of new IP blocks) even in the case of image compression at a high bit depth, thereby reducing power consumption. Detailed descriptions of examples of components included in the encoder 120 are given below with reference to FIG. 3.

The encoder 120 may provide the compressed data CDT to the image processing device 200 through the interface 130. For example, the interface 130 may be implemented as a camera serial interface (CSI) based on a mobile industry processor interface (MIPI). However, the type of the interface 130 is not limited thereto. For example, the interface 130 may be implemented according to various protocol standards.

The image processing device 200 may convert the compressed data CDT received from the image sensor module 100 into an image to be displayed on a display. For example, the image processing device 200 may receive the compressed data CDT from the image sensor module 100, decompress the compressed data CDT to generate decompressed data DDT (e.g., restored image data), and image process (e.g., perform image processing on) the decompressed data DDT.

In an embodiment, the image processing device 200 may receive the compressed data CDT from the image sensor module 100 through the interface 210. The interface 210 may be implemented as the MIPI, similar to the interface 130 provided in the image sensor module 100, but embodiments are not limited thereto. The image processing device 200 may store the received compressed data CDT in the memory 220.

The memory 220 may be a storage location for storing data. The compressed data CDT may be stored in the memory 220. In addition, the memory 220 may store other data, for example, an operating system (OS), various programs, and various data (e.g., compressed data CDT). The memory 220 may include volatile memory, such as dynamic random-access memory (DRAM), and static random-access memory (SRAM), or nonvolatile memory, such as phase-change random-access memory (PRAM), resistive random-access memory (ReRAM), magnetic random-access memory (MRAM), and flash memory. Although FIG. 2A illustrates an example in which the memory 220 is provided in the image processing device 200, embodiments are not limited thereto. For example, in some embodiments, the memory 220 may be provided outside the image processing device 200.

The decoder 230 may read the compressed data CDT from the memory 220 and decompress the compressed data CDT to generate the decompressed data DDT. The decoder 230 may provide the decompressed data DDT to the image signal processor 240.

The decoder 230 may decompress the compressed data CDT in units of pixel groups PG according to a decompression method (or a decoding method) corresponding to the compression method (or the encoding method) performed by the encoder 120 of the image sensor module 100. In this case, the decoder 230 may determine the compression method applied to the pixel group PG based on the compression information included in the bitstream of the compressed data CDT. The decoder 230 may decompress the target pixels of the target pixel group based on the reference values corresponding to the pixels decompressed before the target pixel group to be decompressed (e.g., reference pixels).

As discussed above, according to embodiments, the compression method may refer to a type of compression used to generate or obtain the compressed data, and may also be referred to as a compression process, a compression scheme, or a compression technique. Similarly, the decompression method may refer to a type of decompression used to generate or obtain the decompressed data, and may also be referred to as a decompression process, a decompression scheme, or a decompression technique. In addition, as discussed above, in some embodiments, the encoding may be referred to as compression, and the compression may be referred to as encoding. Similarly, in some embodiments, the decoding may be referred to as decompression, and the decompression may be referred to as decoding.

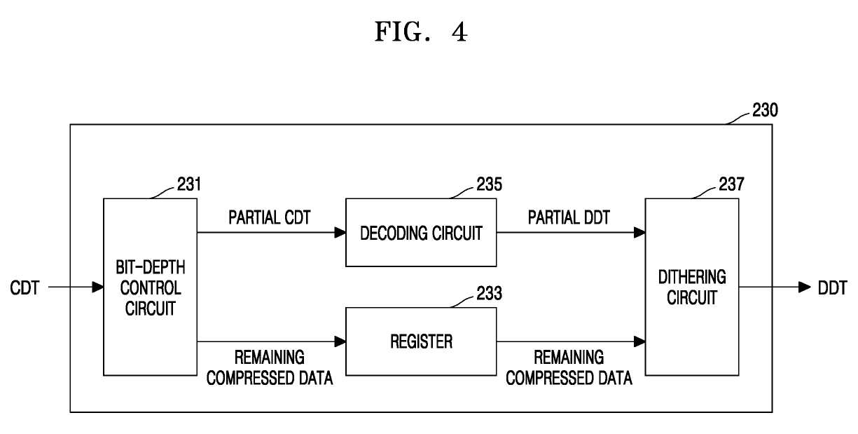

The decoder 230, according to an embodiment, may decompress partial compressed data separated from the compressed data CDT to generate partial decompressed data, and may pack remaining data of the compressed data CDT and random data into partial decompressed data to generate the decompressed data DDT. Accordingly, the decoder 230, according to an embodiment, may improve the decompression efficiency without excessive deformation of IPs included in the image processing device 200 (e.g., increase in size by IP or addition of new IP), even in the case of decompressing an image having a high bit depth, thereby reducing power consumption. Detailed descriptions of examples of components included in the decoder 230 are described below with reference to FIG. 4.

The image signal processor 240 may perform various image processing operations (e.g., image processes) on the received decompressed data DDT. As a non-limiting example, the image signal processor 240 may perform at least one of bad pixel correction, offset correction, lens distortion correction, color gain correction, shading correction, gamma correction, denoising, and sharpening on the decompressed data DDT. In an embodiment, depending on the performance of the image sensor module 100, some of the aforementioned image processing operations may be omitted. For example, when the image sensor module 100 includes a high-quality image sensor 110, bad pixel correction (in particular, a static bad pixel correction) or offset correction may be omitted during the image processing operations.

Each of the encoder 120 and the decoder 230 may be implemented in at least one of software, hardware, and a combination of software and hardware, such as firmware. When the encoder 120 and the decoder 230 are implemented in software, respective functions described above may be implemented as programmed source code and loaded into a storage medium provided in each of the image sensor module 100 and the image processing device 200. A processor (e.g., an image processing processor) provided in each of the image sensor module 100 and the image processing device 200 may execute the software to implement the functions of the encoder 120 and the decoder 230. When the encoder 120 and the decoder 230 are implemented in hardware, the encoder 120 and the decoder 230 may include a logic circuit and a register and perform the respective functions described above based on the register setting.

Although FIG. 2A illustrates an example in which the image processing system 10 includes the image sensor module 100 and the image processing device 200, embodiments are not limited thereto. For example, in some embodiments, the image processing system 10 may be implemented to include only one of the image sensor module 100 and the image processing device 200 or to include a plurality of image sensor modules 100. Although FIG. 2A illustrates an example in which the decoder 230 and the image signal processor 240 are shown as separate components, embodiments are not limited thereto. For example, in some embodiments, the image signal processor 240 may be implemented to include the decoder 230.

With respect to the encoder 120, the decoder 230, and the image processing system 10 according to various embodiments, compression efficiency or decompression efficiency for HDR image data may be improved by performing an encoding or decoding operation based on partial compressed data or partial decompressed data generated by compressing or decompressing at least a portion of the image data.

With respect to the encoder 120, the decoder 230, and the image processing system 10 according to various embodiments, as the compression efficiency or the decompression efficiency of the HDR image data is improved, it is possible to perform compression or decompression of HDR image data without additional hardware logic expansion (e.g., increase in IP size or addition of encoding/decoding IP). It is also possible to reduce the power consumption for compression or decompensation of the HDR images data.

FIG. 3 is a block diagram of an encoder according to an embodiment.

According to embodiments, FIG. 3 is may illustrate examples of components of the encoder 120 in FIG. 2A.

Referring to FIG. 3, the encoder 120 according to an embodiment may include a bit-depth control circuit 121, a register 123, an encoding circuit 125, and a packing circuit 127.

In an embodiment, the bit-depth control circuit 121 may receive image data IDT corresponding to an image obtained using an image sensor (e.g., the image sensor 110). The bit-depth control circuit 121 may receive control data according to an operation scenario of the image sensor through an advanced peripheral bus (APB). The control data may include information about a compression ratio (e.g., 50%) to be used by the encoder 120 according to the operation scenario of the image sensor, a bit-depth (or bit size) (e.g., 10 bits, 12 bits, or the like) of the image data IDT to be compressed by the encoder 120, and a selected encoding method from among the at least one encoding method. The control data may be transferred to the encoder 120 through the APB and stored in a special function register (SFR) set.

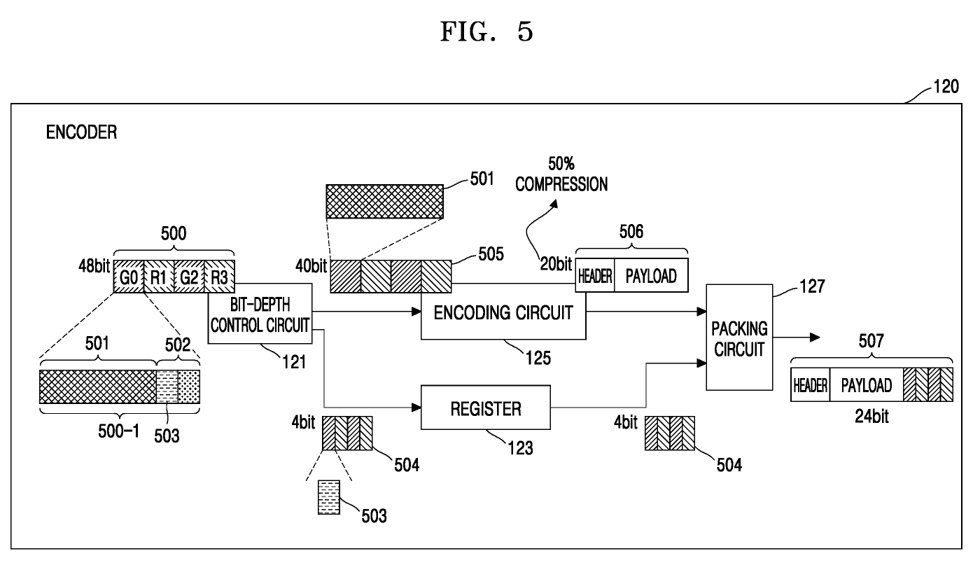

In an embodiment, the bit-depth control circuit 121 may generate first image data IDT_1 by setting N bits extracted from the image data IDT as the first image data IDT_1 and generate second image data IDT_2 by setting some bits of the remaining image data as the second image data IDT_2, based on the received control data. The remaining image data may refer to image data other than the first image data IDT_1 in the image data IDT. The number of bits (e.g., N) extracted from the image data IDT may be determined based on the control data received through the APB. The bit-depth control circuit 121 may generate the first image data IDT_1 and the second image data IDT_2 in various ways according to the encoding method. Examples of processes for generating the first image data IDT_1 and the second image data IDT_2 are described below with reference to FIGS. 5, 7, and 9.

In an embodiment, the bit-depth control circuit 121 may transmit the first image data IDT_1 to the encoding circuit 125 and transmit the second image data IDT_2 to the register 123.

In an embodiment, the register 123 may store the second image data IDT_2 in a first-in first-out (FIFO) register 123. The register 123 may transmit the second image data IDT_2 to the packing circuit 127 according to signaling with the packing circuit 127.

In an embodiment, the encoding circuit 125 may compress the first image data IDT_1 to generate partial compressed data PARTIAL CDT. According to an embodiment, by controlling the bit depth of the image data to be compressed (e.g., the first image data IDT_1) through the bit-depth control circuit 121, the encoder 120 may effectively compress the HDR image data without additionally modifying the encoding circuit 125 (e.g., by maintaining the configuration of the encoding circuit 125 that compresses the image data with a low bit depth). The encoding circuit 125 may transmit the generated partial compressed data PARTIAL CDT to the packing circuit 127.

In an embodiment, the packing circuit 127 may pack the partial compressed data PARTIAL CDT and the second image data IDT_2 to generate the compressed data CDT corresponding to the image data IDT. For example, the packing circuit 127 may generate the compressed data CDT by outputting the second image data IDT_2 in accordance with an output timing of the partial compressed data PARTIAL CDT. The packing circuit 127 may output the generated compressed data CDT to the image processing device. The compressed data CDT may include a header, a payload, and second image data IDT_2, and the header may include information about the encoding method for the image data IDT and the number of quantization times (e.g., a number of times that quantization was performed) during a compression process for the image data IDT.

The encoder 120 according to an embodiment may control the bit depth of image data through the bit-depth control circuit 121 and thus may effectively compress HDR image data (e.g., image data with a high bit depth) without additionally modifying the encoder 120 (e.g., the encoding circuit 125).

In addition, the encoder 120 according to an embodiment may have a technical effect of reducing power consumption used during the compression process by improving the compression efficiency of HDR image data.

FIG. 4 is a block diagram of a decoder according to an embodiment.

According to embodiments, FIG. 4 may illustrate examples of components of the decoder 230 in FIG. 2A.

Referring to FIG. 4, the decoder 230 according to an embodiment may include a bit-depth control circuit 231, a register 233, a decoding circuit 235, and a dithering circuit 237.

In an embodiment, the bit-depth control circuit 231 may receive compressed data CDT corresponding to an image obtained using the image sensor module (e.g., the image sensor module 100 in FIG. 2A). The compressed data CDT may include a header, a payload, and second image data, and the header may include information about the encoding method for the image data IDT and the number of quantization times during the compression process for the image data IDT. The bit-depth control circuit 231 may determine a decoding method of the compressed data CDT among any one of the at least one decoding method, based on the information stored in the header of the compressed data CDT.

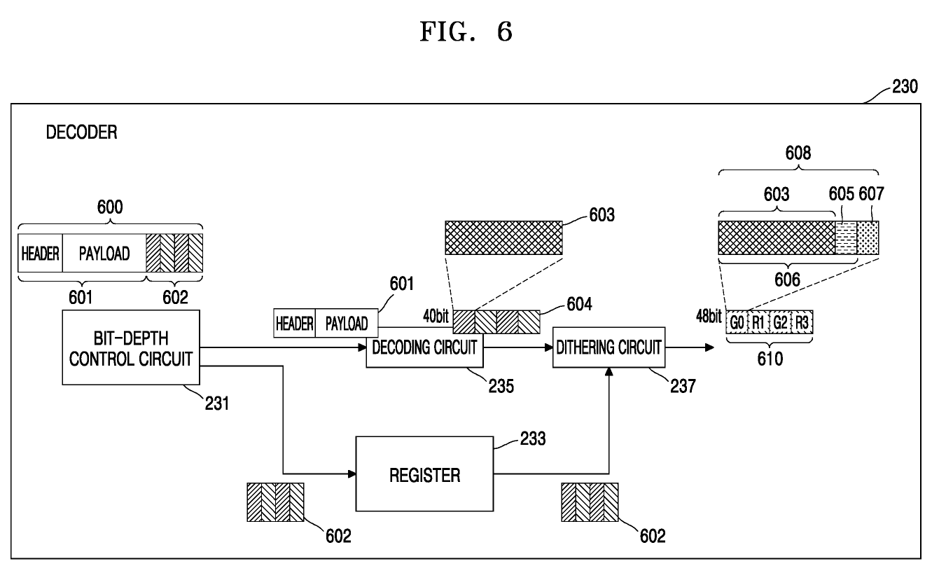

In an embodiment, according to the determined decoding method, the bit-depth control circuit 231 may generate the partial compressed data PARTIAL CDT and the remaining compressed data based on the compressed data CDT. As the other compressed data than the partial compressed data PARTIAL CDT of the compressed data CDT, the remaining compressed data may correspond to the second image data IDT_2 packed in the compressed data CDT in FIG. 3. The bit-depth control circuit 231 may generate the partial compressed data PARTIAL CDT and the remaining compressed data in various ways, according to the decoding method. Various embodiments for a method of generating the partial compressed data PARTIAL CDT and the remaining compressed data are described below with reference to FIGS. 6, 8, and 10.

In an embodiment, the bit-depth control circuit 231 may transmit the partial compressed data PARTIAL CDT to the decoding circuit 235 and transmit the remaining compressed data to the register 233.

In an embodiment, the register 233, which may be a FIFO register, may store the remaining compressed data. The register 233 may transmit the remaining compressed data to the dithering circuit 237 according to signaling with the dithering circuit 237.

In an embodiment, the decoding circuit 235 may decompress the partial compressed data PARTIAL CDT to generate partial decompressed data PARTIAL DDT. By controlling the bit depth of the compressed data (e.g., the partial compressed data PARTIAL CDT) through the bit-depth control circuit 231, the decoder 230 according to an embodiment may effectively decompress the HDR image data without additionally modifying the decoding circuit 235 (e.g., by maintaining the configuration of the decoding circuit 235 that decompresses the image data with a low bit depth). The decoding circuit 235 may transmit the generated partial decompressed data PARTIAL DDT to the dithering circuit 237.

In an embodiment, the dithering circuit 237 may include a random number generator. The dithering circuit 237 may generate random data based on the random number generator.

In an embodiment, the dithering circuit 237 may pack the partial decompressed data PARTIAL DDT, the remaining compressed data, and the random data to generate the decompressed data DDT for the image data IDT. For example, the dithering circuit 237 may generate the decompressed data DDT by outputting the remaining compressed data and the random data in accordance with the output timing of the partial decompressed data PARTIAL DDT. The dithering circuit 237 may output the generated decompressed data DDT to a display, an AP, or the like.

The decoder 230, according to an embodiment, may control the bit depth of the compressed data through the bit-depth control circuit 231 and thus may effectively decompress the HDR image data (e.g., the image data with a high bit depth) without additionally modifying the decoder 230 (e.g., the decoding circuit 235).

Furthermore, the decoder 230, according to an embodiment, may have a technical effect of reducing power consumption used during the decompression process by improving the decompression efficiency of the HDR image data.

Although FIG. 4 illustrates an example in which the bit-depth control circuit 231 and the register 233 are provided outside the decoding circuit 235 in FIG. 4, embodiments are not limited thereto. For example, in some embodiments, the bit-depth control circuit 231 and the register 233 may be provided inside the decoding circuit 235.

FIG. 5 is a diagram illustrating an operation of an encoder according to an embodiment.

According to embodiments, FIG. 5 may illustrate an example of a compression operation of image data 500 by the encoder 120 according to a first encoding method. In the example shown in FIG. 5, the image data 500 may be image data (e.g., 48 bits in total) corresponding to four pixels (e.g., pixel G0, pixel R1, pixel G2, and pixel R3).

Referring to FIG. 5, the bit-depth control circuit 121 may generate first image data 501 and second image data 503 based on pixel data 500-1 (e.g., 12 bits) corresponding to one pixel (e.g., G0). The bit-depth control circuit 121 may generate the first image data 501 by extracting a predetermined number of most significant bits (MSBs) (e.g., 10 bits) from the image data 500-1 (e.g., 12 bits), according to a first encoding method among the at least one encoding method. The bit-depth control circuit 121 may generate an MSB (e.g., 1 bit) from the remaining image data 502 as the second image data 503 according to the first encoding method. The remaining image data 502 may refer to image data remaining after the first image data 501 is extracted from the pixel data 500-1. The bit-depth control circuit 121 may repeat the above-described process to generate the first image data 501 and the second image data 503 for each piece of pixel data 500-1. The bit-depth control circuit 121 may generate a first bitstream 505 (e.g., 40 bits) by combining the first image data 501 for each piece of pixel data 500-1 and transmit the first bitstream 505 to the encoding circuit 125. In addition, the bit-depth control circuit 121 may generate a second bitstream 504 (e.g., 4 bits) by combining the second image data 503 for each piece of pixel data 500-1 to transmit the second bitstream 504 to the register 123.

The register 123 may receive and store the second bitstream 504 from the bit-depth control circuit 121. The register 123 may transmit the second bitstream 504 to the packing circuit 127 according to signaling with the packing circuit 127. The register 123 may include a FIFO register.

The encoding circuit 125 may receive the first bitstream 505 (e.g., 40 bits) from the bit-depth control circuit 121 and compress the first bitstream 505 according to a compression ratio of the first encoding method. For example, when the compression ratio of the first encoding method is 50%, the encoding circuit 125 may compress the first bitstream (40 bits) 505 to generate partial compressed data 506 (e.g., 20 bits). In this case, the partial compressed data 506 may include a header including information about the encoding method for the first bitstream 505 and the number of times of quantization during the compression process for the first bitstream 505, and a payload in which pixel data for each pixel (e.g., pixel data corresponding to the pixel G0, pixel R1, pixel G2, and pixel R3) is compressed/combined and stored (e.g., compressed pixel data is stored). The encoding circuit 125 may transmit the partial compressed data 506 generated according to signaling with the packing circuit 127 to the packing circuit 127.

The packing circuit 127 may pack the partial compressed data 506 and the second bitstream 504 to generate compressed data 507. For example, the packing circuit 127 may output the second bitstream 504 in accordance with the output timing of the partial compressed data 506 to generate the compressed data 507. The packing circuit 127 may output the generated compressed data 507 to the image processing device.

FIG. 6 is a diagram illustrating an operation of a decoder according to an embodiment.

According to embodiments, FIG. 6 may illustrate an example of a decompression operation of compressed data 600 by the decoder 230 according to a first decoding method. The compressed data 600 in FIG. 6 may correspond to the compressed data 507 in FIG. 5.

Referring to FIG. 6, the bit-depth control circuit 231 may separate the compressed data 600 into partial compressed data 601 and remaining compressed data 602, according to a first decoding method. For example, the bit-depth control circuit 231 may generate the partial compressed data 601 and the remaining compressed data 602 by separating the compressed data 600 into the partial compressed data 601 and the remaining compressed data 602 according to the first decoding method. The partial compressed data 601 may include a header including information about the encoding method for image data and the number of times of quantization during the compression process for the image data, and a payload in which compressed pixel data is stored. The first decoding method, among the at least one decoding method, may be determined based on the header of the partial compressed data 601.

The bit-depth control circuit 231 may transmit the partial compressed data 601 to the decoding circuit 235 and transmit the remaining compressed data 602 to the register 233. For example, the remaining compressed data 602 may correspond to the second bitstream 504 in FIG. 5.

The register 233 may receive and store the remaining compressed data 602 from the bit-depth control circuit 231. The register 233 may transmit the remaining compressed data 602 to the dithering circuit 237 according to signaling with the dithering circuit 237. The register 233 may include a FIFO register.

The decoding circuit 235 may receive the partial compressed data 601 from the bit-depth control circuit 231 and may decompress the partial compressed data 601 according to the first decoding method. For example, when the partial compressed data 601 is compressed at a compression ratio of 50%, the decoding circuit 235 may decompress the partial compressed data (601 (e.g., 20 bits) to generate a partial decompressed bitstream (40 bits) 604. In this case, the partial decompressed bitstream 604 (e.g., 40 bits) may include a bitstream generated by combining the partial decompressed data 603 (e.g., 10 bits) for each piece of pixel data. For example, the partial decompressed bitstream 604 (e.g., 40 bits) may include a bitstream including all of the partial decompressed data corresponding to pixel G0, pixel R1, pixel G2, and pixel R3. The decoding circuit 235 may transmit the partial decompressed bitstream 604 (e.g., 40 bits) to the dithering circuit 237 according to signaling with the dithering circuit 237.

The dithering circuit 237 may include a random number generator. The dithering circuit 237 may generate random data 607 based on the random number generator.

The dithering circuit 237 may pack the partial decompressed data 603 (e.g., 10 bits), a portion 605 of the remaining compressed data 602, and the random data 607 to generate decompressed data 608 for each pixel. By outputting the portion 605 of the remaining compressed data 602 in accordance with the output timing of the partial decompressed data 603, the dithering circuit 237 may pack the partial decompressed data 603 and the portion 605 of the remaining compressed data 602 to generate packing data 606. By outputting the random data 607 in accordance with the output timing of the packing data 606, the dithering circuit 237 may pack the packing data 606 and the random data 607 to generate the decompressed data 608. For example, the dithering circuit 237 may generate, according to the first decoding method, the packing data 606 in which the partial decompressed data 603 is MSBs (e.g., 10 bits) and the portion 605 of the remaining compressed data is a least significant bit (LSB) (e.g., 1 bit). The dithering circuit 237 may generate the decompressed data 608 (e.g., 12 bits) in which the packing data 606 is MSBs (e.g., 11 bits) and the random data 607 is an LSB (e.g., 1 bit), according to the first decoding method. The dithering circuit 237 may repeat the above-described method for each pixel to generate the decompressed data 608 corresponding to each pixel. The dithering circuit 237 may generate a decompressed bitstream 610 (e.g., 48 bits) by combining the decompressed data 608 corresponding to each pixel and may output the generated decompressed bitstream 610 (e.g., 48 bits).

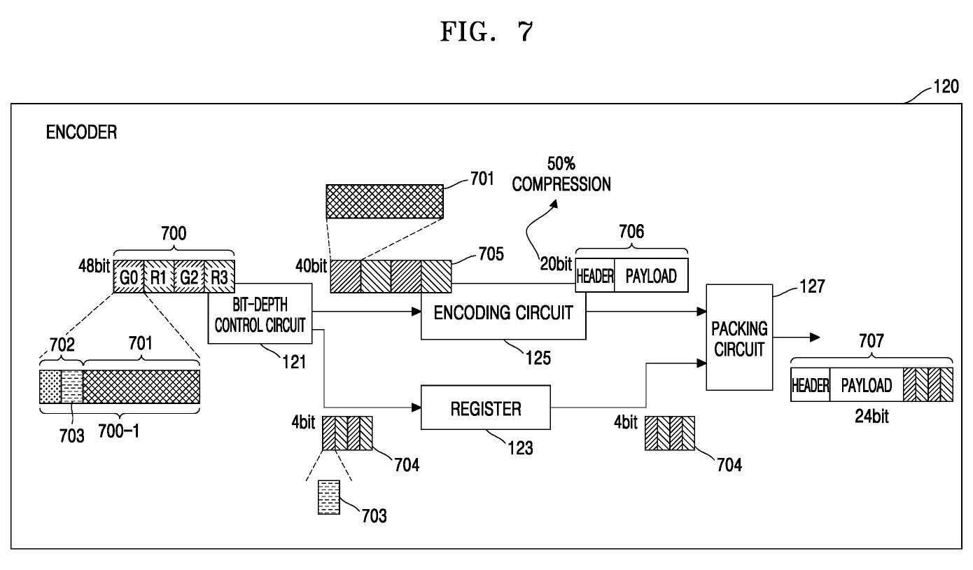

FIG. 7 is a diagram illustrating an operation of an encoder according to an embodiment.

According to embodiments, FIG. 7 may illustrate an example of a compression operation of image data 700 by the encoder 120 according to a second encoding method. In the example shown in FIG. 7, the image data 700 may be image data (e.g., 48 bits in total) corresponding to four pixels (e.g., pixel G0, pixel R1, pixel G2, and pixel R3).

Referring to FIG. 7, the bit-depth control circuit 121 may generate first image data 701 and second image data 703 based on pixel data 700-1 (e.g., 12 bits) corresponding to one pixel (e.g., G0). The bit-depth control circuit 121 may extract a predetermined number of LSBs (e.g., 10 bits) from the pixel data 700-1 (12 bits), according to the second encoding method among the at least one encoding method, to generate the first image data 701. The bit-depth control circuit 121 may generate an LSB (e.g., 1 bit) as the second image data 703 from remaining image data 702, according to the second encoding method. The remaining image data 702 may refer to image data remaining after the first image data 701 is extracted from the pixel data 700-1. The bit-depth control circuit 121 may repeat the above-described process to generate the first image data 701 and the second image data 703 for each piece of pixel data 700-1. The bit-depth control circuit 121 may generate a first bitstream 705 (e.g., 40 bits) by combining the first image data 701 for each piece of pixel data 700-1 and transmit the same to the encoding circuit 125. In addition, the bit-depth control circuit 121 may generate a second bitstream 704 (e.g., 4 bits) by combining the second image data 703 for each piece of pixel data 700-1 and transmit the same to the register 123.

The register 123 may receive and store the second bitstream 704 from the bit-depth control circuit 121. The register 123 may transmit the second bitstream 704 to the packing circuit 127 according to signaling with the packing circuit 127. The register 123 may include a FIFO register.

The encoding circuit 125 may receive the first bitstream 705 (e.g., 40 bits) from the bit-depth control circuit 121 and compress the first bitstream 705 according to a compression ratio of the second encoding method. For example, when the compression ratio of the second encoding method is 50%, the encoding circuit 125 may compress the first bitstream 705 (e.g., 40 bits) to generate partial compressed data 706 (e.g., 20 bits). The partial compressed data 706 may include a header including information about the encoding method for the first bitstream 705 and the number of times of quantization during the compression process for the first bitstream 705, and a payload in which pixel data for each pixel (e.g., pixel data corresponding to pixel G0, pixel R1, pixel G2, and pixel R3) is compressed/combined and stored (e.g., compressed pixel data is stored). The encoding circuit 125 may transmit the partial compressed data 706 generated according to signaling with the packing circuit 127 to the packing circuit 127.

The packing circuit 127 may pack the partial compressed data 706 and the second bitstream 704 to generate compressed data 707. For example, the packing circuit 127 may output the second bitstream 704 in accordance with the output timing of the partial compressed data 706 to generate the compressed data 707. The packing circuit 127 may output the generated compressed data 707 to the image processing device.

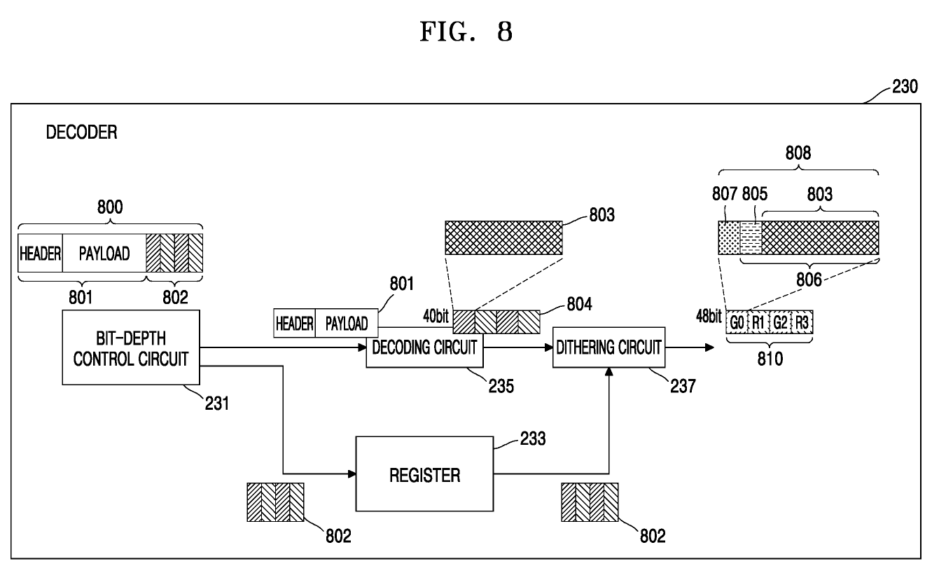

FIG. 8 is a diagram illustrating an operation of a decoder according to an embodiment.

According to embodiments, FIG. 8 may illustrate an example of a decompression operation of compressed data 800 by the decoder 230 according to a second decoding method. The compressed data 800 in FIG. 8 may correspond to the compressed data 707 in FIG. 7.

Referring to FIG. 8, the bit-depth control circuit 231 may separate the compressed data 800 into partial compressed data 801 and remaining compressed data 802 according to the second decoding method. For example, the bit-depth control circuit 231 may generate the partial compressed data 801 and the remaining compressed data 802 by separating the compressed data 800 into the partial compressed data 801 and the remaining compressed data 802 according to the second decoding method. The partial compressed data 801 may include a header including information about the encoding method for image data and the number of times of quantization during the compression process for the image data, and a payload in which compressed pixel data is stored. The second decoding method, among the at least one decoding method, may be determined based on the header of the partial compressed data 801.

The bit-depth control circuit 231 may transmit the partial compressed data 801 to the decoding circuit 235 and transmit the remaining compressed data 802 to the register 233. For example, the remaining compressed data 802 may correspond to the second bitstream 704 in FIG. 7.

The register 233 may receive and store the remaining compressed data 802 from the bit-depth control circuit 231. The register 233 may transmit the remaining compressed data 802 to the dithering circuit 237 according to signaling with the dithering circuit 237. The register 233 may include a FIFO register.

The decoding circuit 235 may receive the partial compressed data 801 from the bit-depth control circuit 231 and decompress the partial compressed data Partial 801 according to the second decoding method. For example, when the partial compressed data 801 is compressed at a compression ratio of 50%, the decoding circuit 235 may decompress the partial compressed data 801 (e.g., 20 bits) to generate a partial decompressed bitstream 804 (e.g., 40 bits). The partial decompressed bitstream 804 (e.g., 40 bits) may include a bitstream generated by combining partial decompressed data 803 (e.g., 10 bits) for each piece of pixel data. For example, the partial decompressed bitstream 804 (e.g., 40 bits) may include a bitstream including all of the partial decompressed data Partial DDT corresponding to pixel G0, pixel R1, pixel G2, and pixel R3. The decoding circuit 235 may transmit the partial decompressed bitstream 804 (e.g., 40 bits) to the dithering circuit 237 according to signaling with the dithering circuit 237.

The dithering circuit 237 may include a random number generator. The dithering circuit 237 may generate random data 807 based on the random number generator.

The dithering circuit 237 may pack the partial decompressed data 803 (e.g., 10 bits), a portion 805 of the remaining compressed data 802, and the random data 807 to generate decompressed data 808 for each pixel. By outputting the portion 805 of the remaining compressed data 802 in accordance with the output timing of the partial decompressed data 803, the dithering circuit 237 may pack the partial decompressed data 803 and the portion 805 of the remaining compressed data 802 to generate packing data 806. By outputting the random data 807 in accordance with the output timing of the packing data 806, the dithering circuit 237 may pack the packing data 806 and the random data 807 to generate the decompressed data 808. For example, the dithering circuit 237 may generate, according to the second decoding method, the packing data 806 in which the portion 805 of the remaining compressed data is an MSB (e.g., 1 bit) and the partial decompressed data 803 is LSBs (e.g., 10 bits). The dithering circuit 237 may generate the decompressed data 808 (e.g., 12 bits) in which the random data 807 is an MSB (e.g., 1 bit) and the packing data 806 is LSBs (e.g., 11 bits), according to the second decoding method. The dithering circuit 237 may repeat the above-described method for each pixel to generate the decompressed data 808 corresponding to each pixel. The dithering circuit 237 may generate a decompressed bitstream 810 (e.g., 48 bits) by combining the decompressed data 808 corresponding to each pixel and may output the generated decompressed bitstream 810 (e.g., 48 bits).

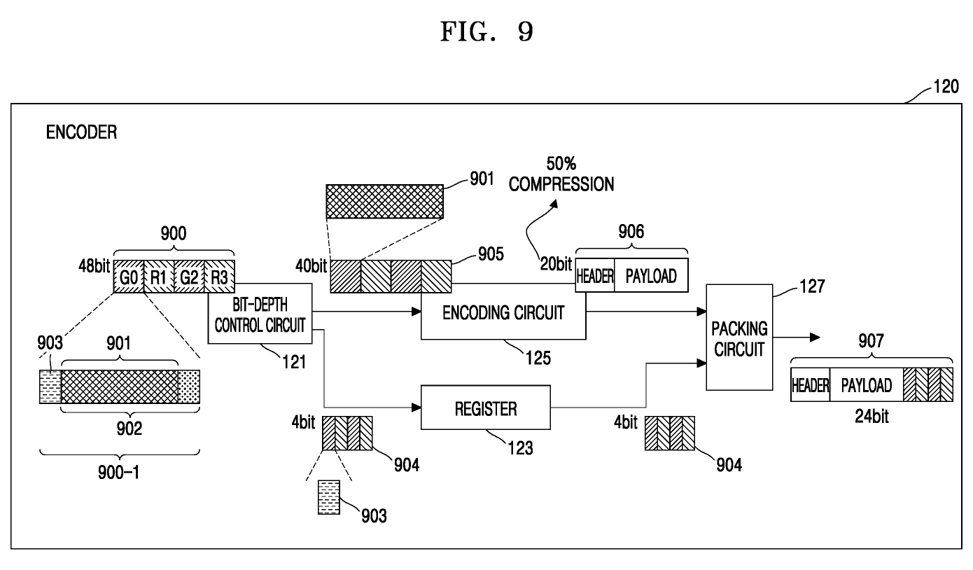

FIG. 9 is a diagram illustrating an operation of an encoder according to an embodiment.

According to embodiments, FIG. 9 may illustrate an example of a compression operation of image data 900 by the encoder 120 according to a third encoding method. In the example shown in FIG. 9, the image data 900 may be image data (e.g., 48 bits in total) corresponding to four pixels (e.g., pixel G0, pixel R1, pixel G2, and pixel R3).

Referring to FIG. 9, the bit-depth control circuit 121 may generate first image data 901 and second image data 903 based on pixel data 900-1 (e.g., 12 bits) corresponding to one pixel (e.g., G0). The bit-depth control circuit 121 may generate an MSB (e.g., 1 bit) in the image data 900-1 as the second image data 903 according to the third encoding method among the at least one encoding method. The bit-depth control circuit 121 may generate the first image data 901 by extracting a predetermined number of LSBs (e.g., 10 bits) from the image data 900-1 (e.g., 12 bits) according to the third encoding method. The bit-depth control circuit 121 may generate MSBs (e.g., 10 bits) as the first image data 901 from the remaining image data 902 according to the third encoding method. The remaining image data 902 may refer to image data remaining after the second image data 903 is extracted from the pixel data 900-1. The bit-depth control circuit 121 may repeat the above-described process to generate the first image data 901 and the second image data 903 for each piece of pixel data 900-1. The bit-depth control circuit 121 may generate a first bitstream 905 (e.g., 40 bits) by combining the first image data 901 for each piece of pixel data 900-1 and may transmit the same to the encoding circuit 125. In addition, the bit-depth control circuit 121 may generate a second bitstream 904 (e.g., 4 bits) by combining the second image data 903 for each piece of pixel data 900-1 and transmit the same to the register 123.

The register 123 may receive and store the second bitstream 904 from the bit-depth control circuit 121. The register 123 may transmit the second bitstream 904 to the packing circuit 127 according to signaling with the packing circuit 127. The register 123 may include a FIFO register.

The encoding circuit 125 may receive the first bitstream 905 (e.g., 40 bits) from the bit-depth control circuit 121 and compress the first bitstream 905 according to a compression ratio of the third encoding method. For example, when the compression ratio of the third encoding method is 50%, the encoding circuit 125 may compress the first bitstream 905 (e.g., 40 bits) to generate partial compressed data 906 (e.g., 20 bits). The partial compressed data 906 may include a header including information about the encoding method for the first bitstream 905 and the number of times of quantization during the compression process for the first bitstream 905, and a payload in which pixel data for each pixel (e.g., pixel data corresponding to pixel G0, pixel R1, pixel G2, and pixel R3) is compressed/combined and stored (e.g., compressed pixel data is stored). The encoding circuit 125 may transmit the partial compressed data 906 generated according to signaling with the packing circuit 127 to the packing circuit 127.

The packing circuit 127 may pack the partial compressed data 906 and the second bitstream 904 to generate compressed data 907. For example, the packing circuit 127 may output the second bitstream 904 in accordance with the output timing of the partial compressed data 906 to generate the compressed data 907. The packing circuit 127 may output the generated compressed data 907 to the image processing device.

Although encoding operations of the encoder based on the first to third encoding methods, according to an embodiment, are described with reference to FIGS. 5, 7, and 9, embodiments are not limited thereto. The encoder according to an embodiment may perform the encoding operations (or compression operations) based on second image data and partial compressed data generated according to various encoding methods.

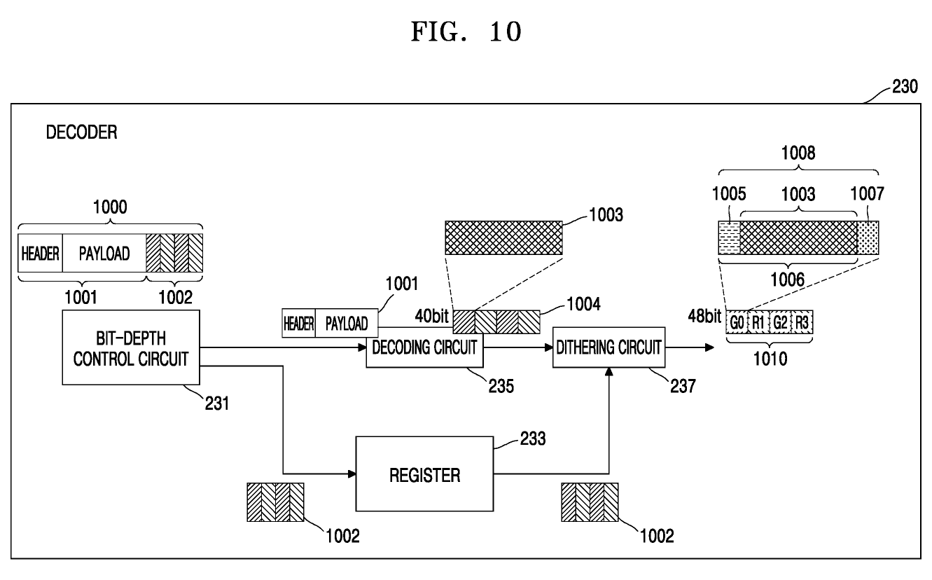

FIG. 10 is a diagram illustrating an operation of a decoder according to an embodiment.

According to embodiments, FIG. 10 may illustrate an example of a decompression operation of compressed data 1000 by the decoder 230 according to a third decoding method. The compressed data 1000 in FIG. 10 may correspond to the compressed data 907 in FIG. 9.

Referring to FIG. 10, the bit-depth control circuit 231 may separate the compressed data 1000 into partial compressed data 1001 and remaining compressed data 1002 according to the third decoding method. For example, the bit-depth control circuit 231 may generate the partial compressed data 1001 and the remaining compressed data 1002 by separating the compressed data 1000 into the partial compressed data 1001 and the remaining compressed data 1002 according to the third decoding method. The partial compressed data 1001 may include a header including information about the encoding method for image data and the number of times of quantization during the compression process for the image data, and a payload in which compressed pixel data is stored. The third decoding method, among the at least one decoding method, may be determined based on the header of the partial compressed data 1001.

The bit-depth control circuit 231 may transmit the partial compressed data 1001 to the decoding circuit 235 and transmit the remaining compressed data 1002 to the register 233. For example, the remaining compressed data 1002 may correspond to the second bitstream 904 in FIG. 9.

The register 233 may receive and store the remaining compressed data 1002 from the bit-depth control circuit 231. The register 233 may transmit the remaining compressed data 1002 to the dithering circuit 237 according to signaling with the dithering circuit 237. The register 233 may include a FIFO register.

The decoding circuit 235 may receive the partial compressed data 1001 from the bit-depth control circuit 231 and may decompress the partial compressed data 1001 according to the third decoding method. For example, when the partial compressed data 1001 is compressed at a compression ratio of 50%, the decoding circuit 235 may decompress the partial compressed data 1001 (e.g., 20 bits) to generate a partial decompressed bitstream 1004 (e.g., 40 bits). The partial decompressed bitstream 1004 (e.g., 40 bits) may include a bitstream generated by combining partial decompressed data 1003 (e.g., 10 bits) for each piece of pixel data. For example, the partial decompressed bitstream 1004 (e.g., 40 bits) may include a bitstream including all of the partial decompressed data 1003 corresponding to pixel G0, pixel R1, pixel G2, and pixel R3. The decoding circuit 235 may transmit the partial decompressed bitstream 1004 (e.g., 40 bits) to the dithering circuit 237 according to signaling with the dithering circuit 237.

The dithering circuit 237 may include a random number generator. The dithering circuit 237 may generate random data 1007 based on the random number generator.

The dithering circuit 237 may pack the partial decompressed data 1003 (e.g., 10 bits), a portion 1005 of the remaining compressed data 1002, and the random data 1007 to generate decompressed data 1008 for each pixel. By outputting the portion 1005 of the remaining compressed data 1002 in accordance with the output timing of the partial decompressed data 1003, the dithering circuit 237 may pack the partial decompressed data 1003 and the portion 1005 of the remaining compressed data 1002 to generate packing data 1006. By outputting the random data 1007 in accordance with the output timing of the packing data 1006, the dithering circuit 237 may pack the packing data 1006 and the random data 1007 to generate the decompressed data 1008. For example, the dithering circuit 237 may generate the packing data 1006 in which the portion 1005 of the remaining compressed data is an MSB (e.g.., 1 bit) and the partial decompressed data 1003 is LSBs (e.g., 10 bits), according to the third decoding method. The dithering circuit 237 may generate the decompressed data (e.g., 12 bits) 1008 in which the packing data 1006 is MSBs (e.g., 11 bits) and the random data 1007 is an LSB (e.g., 1 bit), according to the third decoding method. The dithering circuit 237 may repeat the above-described method for each pixel to generate the decompressed data 1008 corresponding to each pixel. The dithering circuit 237 may generate a decompressed bitstream 1010 (e.g., 48 bits) by combining the decompressed data 1008 corresponding to each pixel and may output the generated decompressed bitstream 1010 (e.g., 48 bits).

Although examples of the decoding operations of the decoder according to the first to third decoding methods, according to an embodiment, are described with reference to FIGS. 6, 8, and 10, embodiments are not limited thereto. The decoder according to an embodiment may perform the decoding operation (or a decompression operation) based on partial decompressed data, remaining compressed data, and random data generated according to various decoding methods.

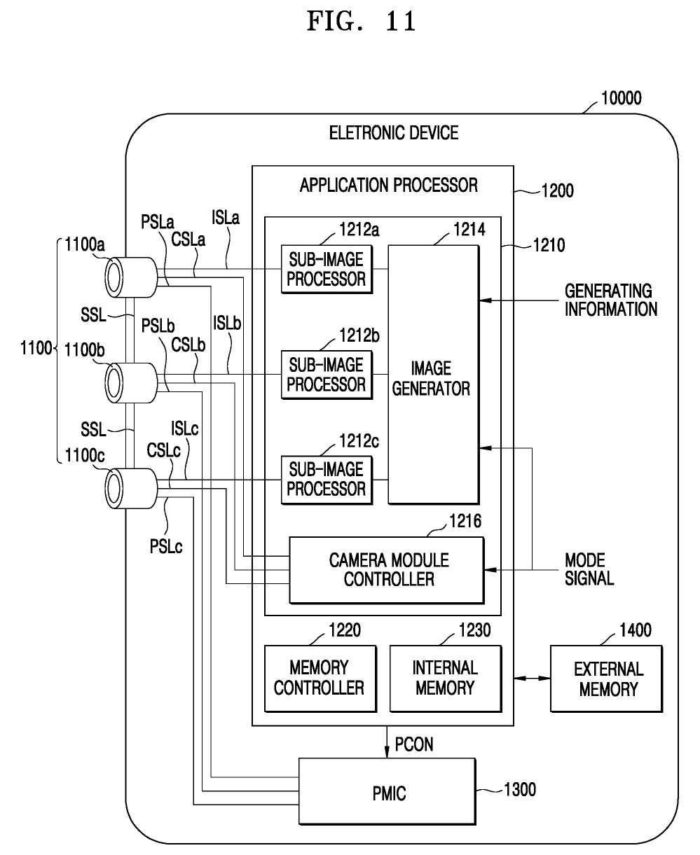

FIG. 11 is a block diagram of an electronic device including a multi-camera module, according to an embodiment.

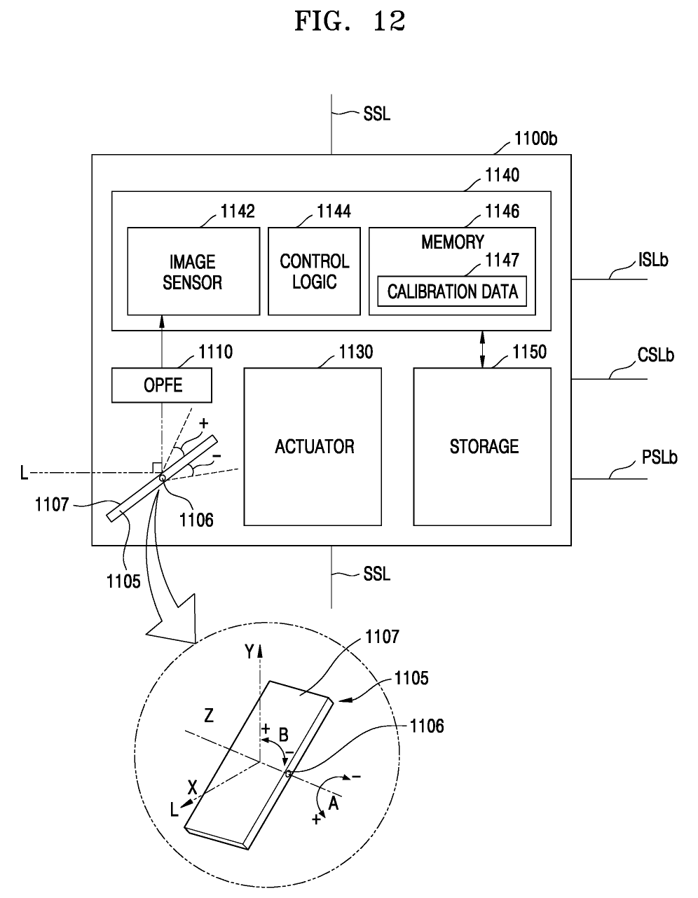

FIG. 12 is a detailed block diagram of a camera module according to an embodiment.

Referring to FIG. 11, an electronic device 10000 may include a plurality of camera modules 1100, an application processor 1200, a PMIC 1300, and storage 1400 (e.g., external memory).

The plurality of camera modules 1100 may be a camera module group, and may include, for example, a camera module 1100a, a camera module 1100b, and a camera module 1100c. Although an embodiment in which three camera modules are arranged is shown herein, embodiments are not limited thereto. In an embodiment, the plurality of camera modules 1100 may include only two camera modules or may be modified to include k camera modules (where k is a natural number of 4 or greater).

Hereinafter, a detailed configuration of a camera module 1100b is described in more detail with reference to FIG. 12, but the following description may be equally applied to other camera modules 1100a and 1100b, according to an embodiment.

Referring to FIG. 12, the camera module 1100b may include a prism 1105, an optical path folding element (OPFE) 1110, an actuator 1130, an image sensing device 1140, and storage 1150.

The prism 1105 may include a reflective surface 1107 of a light reflective material to change the path of externally incident light L.

In an embodiment, the prism 1105 may change the path of light L incident in a first direction X to a second direction Y perpendicular to the first direction X. In addition, the prism 1105 may rotate the reflective surface 1107 of the light reflective material about a central axis 1106 in direction A or in direction B to change the path of light L incident in the first direction X to the second direction Y perpendicular to the first direction X. The OPFE 1110 may also move in a third direction Z perpendicular to the first direction X and the second direction Y.

In an embodiment, as shown, the maximum rotation angle of the prism 1105 in direction A may be 15 degrees or less in the plus (+) direction A and may be 15 degrees or greater in the minus (−) direction A. However, embodiments are limited thereto.

In an embodiment, the prism 1105 may move in the plus (+) or minus (−) direction B within 20 degrees, or between 10 degrees and 20 degrees, or between 15 degrees and 20 degrees. The angle by which the prism 1105 moves in the plus (+) direction B may be the same as or almost similar to the angle by which the prism 1105 moves in the minus (−) direction B, within a range of about 1 degree.

In an embodiment, the prism 1105 may move the reflective surface 1107 of the light reflective material in the third direction (e.g., Z direction) parallel to the extension direction of the central axis 1106.

In an embodiment, the camera module 1100b may include two or more prisms, which may vary the path of the light L incident in the first direction X to the second direction Y perpendicular to the first direction X, back to the first direction X or the third direction Z, and then back to the second direction Y.

The OPFE 1110 may, for example, include optical lenses consisting of m (where m is a natural number) groups. The m lenses may move in the second direction Y to change an optical zoom ratio of the camera module 1100b. For example, when a basic optical zoom ratio of the camera module 1100b is referred to as Z and m optical lenses included in the OPFE 1110 are moved, the optical zoom ratio of the camera module 1100b may be changed to 3Z, 5Z, or 5Z or greater.

The actuator 1130 may move the OPFE 1110 or an optical lens to a specific position. For example, the actuator 1130 may adjust the position of the optical lens to locate the image sensor 1142 at the focal length of the optical lens for accurate sensing.

The image sensing device 1140 may include an image sensor 1142, control logic 1144, and memory 1146. According to embodiments, at least one of the image sensor module 100 of FIG. 2A and the camera module 1100b of FIG. 11 may be used as the image sensing device 1140.

The image sensor 1142 may sense an image of a sensing target by using the light L provided through the optical lens. The control logic 1144 may process the sensed image and control the overall operation of the camera module 1100b. For example, the control logic 1144 may control the operation of the camera module 1100b according to a control signal provided through a control signal line CSLb and may extract image data (e.g., a face, an arm, or a leg of a person in the image) corresponding to a specific image from the sensed image or perform image processing, such as noise reduction.

In an embodiment, the control logic 1144 may include the encoder (e.g., the encoder 120 of FIG. 2A) and may encode the sensed image or the image-processed image. As described above, the encoder 120 may compress an image in units of pixel groups and may compress the image according to an offset encoding method with respect to the pixel groups in the isolated region.

The memory 1146 may store information required for the operation of the camera module 1100b, such as calibration data 1147. The calibration data 1147, which is information required for the camera module 1100b to generate the image data using the light L provided from the outside, may include, for example, information about a degree of rotation, information about a focal length, information about an optical axis, and the like. When the camera module 1100b is implemented in the form of a multi-state camera in which a focal length varies according to the position of the optical lens, the calibration data 1147 may include a focal length value for each position (or state) of the optical lens and information related to auto-focusing.

In an embodiment, the compressed data may be stored in the memory 1146. The memory 1146 may also be used as the register 123 of the encoder 120 and the register 233 of the decoder 230.

The storage 1150 may store image data sensed by the image sensor 1142. The storage 1150 may be arranged outside the image sensing device 1140 and may be implemented in a stacked form with a sensor chip constituting the image sensing device 1140. In an embodiment, the image sensor 1142 may include a first chip, and the control logic 1144, the storage 1150, and the memory 1146 include a second chip, so that the two chips may be stacked.

In an embodiment, the storage 1150 may be implemented as electrically erasable programmable read-only memory (EEPROM). However, embodiments are not limited thereto. In an embodiment, the image sensor 1142 may be configured as a pixel array, and the control logic 1144 may include an analog-to-digital converter and an image signal processor for processing a sensed image.

Referring to FIGS. 11 and 12, in an embodiment, each of the plurality of camera modules 1100 may include the actuator 1130. Accordingly, each of the plurality of camera modules 1100 may include the same or different calibration data 1147 according to the operation of the actuator 1130 included therein.

In an embodiment, the camera module (e.g., the camera module 1100b) of the plurality of camera modules 1100 may include a folded lens-type camera module including the prism 1105 and the OPFE 1110 described above. The other camera modules (e.g. the camera module 1100a and the camera module 1100c) may include vertical-type camera modules that do not include the prism 1105 or the OPFE 1110 but are not limited thereto.

In an embodiment, the camera module (e.g., the camera module 1100c) of the plurality of camera modules 1100 may include a vertical-type depth camera that extracts depth information using, for example, an infrared ray (IR). In this case, the application processor 1200 may merge image data provided from the depth camera with the image data provided from another camera module (e.g., the camera module 1100a or the camera module 1100b) to generate a three-dimensional (3D) depth image.

In an embodiment, at least two camera modules (e.g., the camera module 1100a and the camera module 1100b) in the plurality of camera modules 1100 may have different fields of view. In this case, for example, the optical lenses of at least two camera modules (e.g., the camera module 1100a and the camera module 1100b) of the plurality of camera modules 1100 may be different from each other but are not limited thereto.

In addition, in an embodiment, the fields of view of the plurality of camera modules 1100 may be different from each other. For example, the camera module 1100a may include an ultrawide camera, the camera module 1100b may include a wide camera, and the camera module 1100c may include a tele-camera, but are not limited thereto. In this case, the optical lenses respectively included in the plurality of camera modules 1100 may also be different from each other but are not limited thereto.

In an embodiment, the plurality of camera modules 1100 may be physically separate from each other. That is, rather than dividing the sensing area of one image sensor 1142 into the plurality of camera modules 1100, the image sensor 1142 may be arranged independently inside each of the plurality of camera modules 1100.

Referring back to FIG. 11, the application processor 1200 may include an image processor 1210, a memory controller 1220, and internal memory 1230. The application processor 1200 may be implemented separately from the plurality of camera modules 1100, for example, as separate semiconductor chips.

The image processor 1210 may include a plurality of sub-image processors 1212 (e.g., a sub-image processor 1212a, a sub-image processor 1212b, and a sub-image processor 1212c), an image generator 1214, and a camera module controller 1216.

The image processor 1210 may include the plurality of sub-image processors 1212, the number of which corresponds to the number of the plurality of camera modules 1100.

The image data generated from the camera module 1100a may be provided to the sub-image processor 1212a through an image signal line ISLa, the image data generated from the camera module 1100b may be provided to the sub-image processor 1212b through an image signal lines ISLb, and the image data generated from the camera module 1100c may be provided to the sub-image processor 1212c through an image signal line ISLc. Such image data transmission may be performed using, for example, but not limited to, the CSI based on the MIPI.

In an embodiment, at least one of the plurality of sub-image processors 1212 may include the decoder (e.g., the decoder 230 of FIG. 2A). The plurality of sub-image processors 1212 may include the decoder 230 to decompress the compressed image data when the corresponding plurality of camera modules 1100 include the encoder (e.g., the encoder 120 in FIG. 2A).

In an embodiment, the image processing device 200 of FIG. 2A may be implemented as at least one of the plurality of sub-image processors 1212, and the at least one of the plurality of sub-image processors 1212 may include the encoder (e.g., the encoder 120 of FIG. 2A) and the decoder (e.g., the decoder 230 of FIG. 2A).

In an embodiment, the sub-image processor corresponding to the encoder (e.g., the encoder 120 in FIG. 2A) among the plurality of sub-image processors 1212 may generate, according to at least one encoding method, first image data and second image data based on the image data, compress the first image data to generate partial compressed data, and pack the second image data into the partial compressed data to generate a plurality of bitstreams (e.g., data streams obtained by compressing the image data).

In an embodiment, the sub-image processor corresponding to the encoder (e.g., the encoder 120 of FIG. 2A) may, according to the first encoding method among the at least one encoding method, extract a predetermined number of MSBs from the image data to generate the first image data and may generate MSBs of the remaining image data as the second image data. The plurality of bitstreams may be generated based thereon.

In an embodiment, the sub-image processor corresponding to the encoder (e.g., the encoder 120 of FIG. 2A) may, according to the second encoding method among the at least one encoding method, extract a predetermined number of LSBs from the image data to generate the first image data and may generate LSBs of the remaining image data as the second image data. A plurality of bitstreams may be generated based thereon.

In an embodiment, the sub-image processor corresponding to the encoder (e.g., the encoder 120 in FIG. 2A) may, according to the third encoding method among the at least one encoding method, generate MSBs of the image data as the second image data and may extract a predetermined number of MSBs from the remaining image data to generate the first image data. A plurality of bitstreams may be generated based thereon.

For convenience of description, the compression operation of the sub-image processor corresponding to the encoder (e.g., the encoder 120 in FIG. 2A) according to the first to third encoding methods is described, but embodiments are not limited thereto. The sub-image processor corresponding to the encoder (e.g., the encoder 120 in FIG. 2A) according to an embodiment may generate the first to second image data, according to various encoding methods, and generate a plurality of bitstreams that are compressed data based thereon.

In an embodiment, according to the at least one decoding method, a sub-image processor corresponding to the decoder (e.g., the decoder 230 in FIG. 2A) in the plurality of sub-image processors 1212 may separate the plurality of bitstreams into the partial compressed data and the second image data, decompress the partial compressed data to recover the first image data, and pack the recovered first image data, the second image data, and random data, based on the at least one decoding method, to recover the image data. The sub-image processor corresponding to the decoder (e.g., the decoder 230 in FIG. 2A) may include a random number generator and generate random data based on the random number generator.

In an embodiment, a sub-image processor corresponding to the decoder (e.g., the decoder 230 in FIG. 2A) in the plurality of sub-image processors 1212 may generate, according to the first decoding method among the at least one decoding method, the packing data in which the partial decompressed data is an MSB and a portion of the remaining compressed data is an LSB, and generate, according to the first decoding method, the decompressed data in which the packing data is an MSB and the random data is an LSB. In addition, the sub-image processor corresponding to the decoder (e.g., the decoder 230 in FIG. 2A) may generate a plurality of bitstreams (e.g., a data stream obtained by decompressing the compressed data) by combining the decompressed data for each pixel.

In an embodiment, a sub-image processor corresponding to the decoder (e.g., the decoder 230 in FIG. 2A) in the plurality of sub-image processors 1212 may generate, according to the second decoding method in the at least one decoding method, the packing data in which the portion of the remaining compressed data is an MSB and the partial decompressed data is an LSB, and generate, according to the second decoding method, the decompressed data in which the random data is an MSB and the packing data is an LSB. In addition, the sub-image processor corresponding to the decoder (e.g., the decoder 230 in FIG. 2A) may combine the decompressed data for each pixel to generate the plurality of bitstreams (e.g., data streams obtained by decompressing the compressed data).

In an embodiment, a sub-image processor corresponding to the decoder (e.g., the decoder 230 in FIG. 2A) in the plurality of sub-image processors 1212 may generate, according to the third decoding method among the at least one decoding method, the packing data in which a portion of the remaining compressed data is an MSB and the partial decompressed data is an LSB, and generate, according to the third decoding method, the decompressed data in which the packing data is an MSB and the random data is an LSB. In addition, the sub-image processor corresponding to the decoder (e.g., the decoder 230 in FIG. 2A) may combine the decompressed data for each pixel to generate the plurality of bitstreams (e.g., data streams obtained by decompressing the compressed data).

For convenience of description, the decompression operations of the sub-image processor corresponding to the decoder (e.g., the decoder 230 in FIG. 2A) according to the first to third encoding methods are described, but embodiments are not limited thereto. The sub-image processor corresponding to the decoder (e.g., the decoder 230 in FIG. 2A) according to an embodiment may generate the partial decompressed data, the packing data, and the random data, according to various decoding methods, and generate the plurality of bitstreams that are decompressed data based thereon.

In an embodiment, one sub-image processor may be arranged to correspond to a plurality of camera modules. For example, the sub-image processors 1212a and 1212c may not be implemented separately from each other as illustrated, but are integrated into one sub-image processor. The image data provided from the camera module 1100a and the camera module 1100c may be selected through a selector (e.g., a multiplexer) or the like and then provided to the integrated sub-image processor. The sub-image processor 1212b may not be integrated thereto. The sub-image processor 1212b may receive the image data from the camera module 1100b.

In addition, in an embodiment, the image data generated from the camera module 1100a may be provided to the sub-image processor 1212a through the image signal line ISLa, the image data generated from the camera module 1100b may be provided to the sub-image processor 1212b through the image signal line ISLb, and the image data generated by the camera module 1100c may be provided to sub-image processor 1212c through the image signal line ISLc. Then, the image data processed by the sub-image processor 1212b may be directly provided to the image generator 1214. However, one of the image data processed by the sub-image processor 1212a and the image data processed by the sub-image processor 1212c may be selected through the selector (e.g., a multiplexer) or the like and then provided to the image generator 1214.

Each of the sub-image processors 1212 may perform image processing, such as bad pixel correction, 3A adjustment (auto-focus correction, auto-white balance, auto-exposure), noise reduction, sharpening, gamma control, remosaic, or the like on the image data provided from the camera modules 1100a, 1100b, and 1100c.

In an embodiment, remosaic signal processing may be performed by each of the plurality of camera modules 1100 and then provided to the plurality of sub-image processors 1212.

The image data processed by each of the plurality of sub-image processors 1212 may be provided to the image generator 1214. The image generator 1214 may generate an output image by using the image data provided by each of the plurality of sub-image processors 1212, according to image generating information or a mode signal.

For example, the image generator 1214 may merge at least a portion of the image data generated from the plurality of sub-image processors 1212 according to the image generating information or the mode signal to generate the output image. In addition, the image generator 1214 may select any one of the image data generated from the plurality of sub-image image processors 1212 according to the image generating information or the mode signal to generate the output image.

In an embodiment, the image generating information may include a zoom signal or a zoom factor. In addition, in an embodiment, the mode signal may include, for example, a signal based on a mode selected from a user.

When the image generating information is a zoom signal (zoom factor) and each of the camera modules 1100 has a different field of view, the image generator 1214 may perform different operations according to the type of the zoom signal. For example, when the zoom signal is a first signal, the output image may be generated by using the image data output from the sub-image processor 1212a, among the image data output from the sub-image processor 1212a and the image data output from the sub-image processor 1212c, and the image data output from the sub-image processor 1212b. When the zoom signal is a second signal different from the first signal, the image generator 1214 may generate the output image by using the image data output from the sub-image processor 1212c, among the image data output from the sub-image processor 1212a and the image data output from the sub-image processor 1212c, and the image data output from the sub-image processor 1212b. When the zoom signal is a third signal different from the first and second signals, the image generator 1214 may select any one of the image data output from the plurality of sub-image processors 1212 to generate the output image without performing such image data merging. However, embodiments are not limited thereto. The method of processing image data may be modified as needed.

In an embodiment, the image processor 1210 may further include the selector that selects and transmits the outputs of the plurality of sub-image processors 1212to the image generator 1214.

In this case, the selector may perform different operations according to the zoom signal or the zoom factor. For example, when the zoom signal is a fourth signal (e.g., the zoom ratio is the first ratio), the selector may select and transmit any one of the outputs of the plurality of sub-image processors to the image generator 1214.

In addition, when the zoom signal is a fifth signal (e.g., the zoom ratio is a second ratio) different from the fourth signal, the selector may sequentially transmit p outputs (where p is a natural number of 2 or greater) among the outputs of the plurality of sub-image processors 1212 to the image generator 1214. For example, the selector may sequentially transmit the outputs of the sub-image processor 1212b and the sub-image processor 1212c to the image generator 1214. In addition, the selector may sequentially transmit the outputs of the sub-image processor 1212a and the sub-image processor 1212b to the image generator 1214. The image generator 1214 may merge the sequentially provided p outputs to generate one output image.

The image processing, such as demosaic, down scaling to a video/preview resolution, gamma correction, and HDR processing, is performed in advance by the plurality of sub-image processors 1212, and then the processed image data is transferred to the image generator 1214. Accordingly, the image merging operation of the image generator 1214 may be performed at high speed even when the processed image data is provided to the image generator 1214 by one signal line through the selector.

In an embodiment, the image generator 1214 may receive a plurality of image data having different exposure times from at least one of the plurality of sub-image processors 1212 and perform HDR processing on the plurality of image data, thereby generating merged image data having an increased dynamic range.

The camera module controller 1216 may provide a control signal to each camera module of the plurality of camera modules 1100. The control signals generated from the camera module controller 1216 may be provided to the corresponding camera modules of the plurality of camera modules 1100 through separate control signal lines CSLa, CSLb, and CSLc.

Any one of the pluralities of camera modules 1100 may be designated as a master camera (e.g., the camera module 1100b) according to the image generating information including the zoom signal or the mode signal, and the remaining camera modules (e.g.,1100a and 1100c) may be designated as slave cameras. This information may be included in the control signals and provided to the corresponding camera modules of the plurality of camera modules 1100 through separate control signal lines CSLa, CSLb, and CSLc.

The camera modules operating as a master and a slave may be changed according to a zoom factor or an operation mode signal. For example, when the field of view of the camera module 1100a is wider than the field of view of the camera module 1100b and the zoom factor indicates a low zoom ratio, the camera module 1100a may operate as a master and the camera module 1100b may operate as a slave. Conversely, when the zoom factor indicates a high zoom ratio, the camera module 1100b may operate as a master and the camera module 1100a may operate as a slave.

In an embodiment, the control signal provided from the camera module controller 1216 to each camera module of the plurality of camera modules 1100 may include a sync enable signal. For example, when the camera module 1100b is a master camera and the camera modules 1100a and 1100c are slave cameras, the camera module controller 1216 may transmit a sync enable signal to the camera module 1100b. The camera module 1100b provided with the sync enable signal may generate a sync signal based on the provided sync enable signal and provide the generated sync signal to the camera modules 1100a and 1100c through a sync signal line SSL. The camera module 1100b and the camera modules 1100a and 1100c may be synchronized with the sync signal to transmit the image data to the application processor 1200.

In an embodiment, the control signals provided from the camera module controller 1216 to the plurality of camera modules 1100 may include mode information according to the mode signal. Based on this mode information, the plurality of camera modules 1100 may operate in a first operation mode and a second operation mode with respect to the sensing speed.

The plurality of camera modules 1100a, 1100b, and 1100c, in the first operation mode, may generate an image signal at a first speed (e.g., generate an image signal at a first frame rate), encode the same at a second speed that is higher than the first speed (e.g., encode an image signal at a second frame rate higher than the first frame rate), and transmit the encoded image signal to the application processor 1200. The second speed may be 30 times or less the first speed.

The application processor 1200 may store the received image signal, that is, the encoded image signal, in the internal memory 1230 provided therein or the storage 1400 outside the application processor 1200, then read and decode the encoded image signal from the internal memory 1230 or the storage 1400, and display the image data generated based on the decoded image signal. For example, a corresponding one of the plurality of sub-image processors 1212 of the image processor 1210 may perform decoding and may also perform image processing on the decoded image signal.

The plurality of camera modules 1100 may generate, in the second operation mode, the image signal at a third speed that is lower than the first speed (e.g., generate an image signal at a third frame rate that is less than the first frame rate) and transmit the image signal to the application processor 1200. The image signal provided to the application processor 1200 may include an unencoded signal. The application processor 1200 may perform image processing on the received image signal or store the image signal in the internal memory 1230 or the storage 1400.

The PMIC 1300 may supply power, e.g., a power supply voltage, to each of the plurality of camera modules 1100a, 1100b, and 1100c. For example, the PMIC 1300 may supply, under the control by the application processor 1200, a first power to the camera module 1100a through a power signal line PSLa, a second power to the camera module 1100b through a power signal line PSLb, and a third power to the camera module 1100c through a power signal line PSLc.

The PMIC 1300 may generate power corresponding to each of the plurality of camera modules 1100 in response to a power control signal PCON from the application processor 1200 and may also adjust the level of the power. The power control signal PCON may include a power control signal for each operation mode of the plurality of camera modules 1100a, 1100b, and 1100c. For example, the operation mode may include a low power mode, and the power control signal PCON may include information about a camera module operating in a low power mode and a power level to be set. The level of power provided to each of the plurality of camera modules 1100 may be the same or different. In addition, the level of power may be dynamically changed.

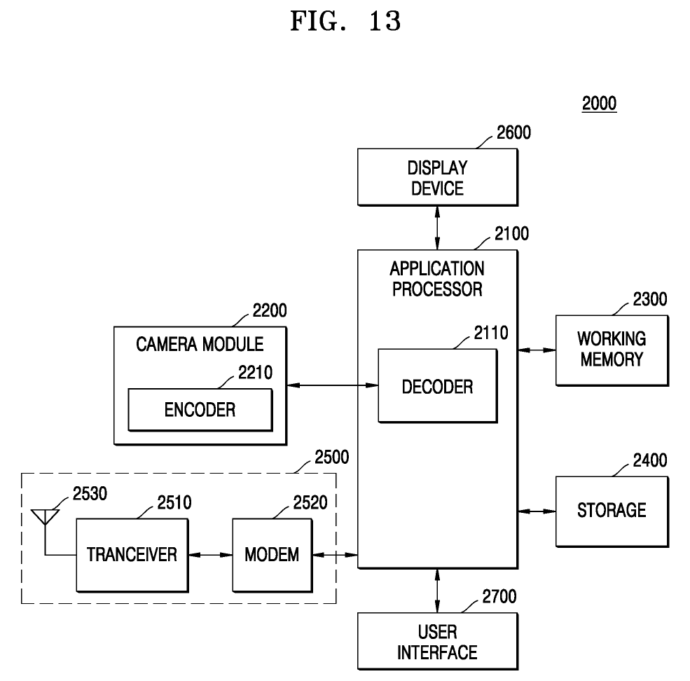

FIG. 13 is a schematic block diagram of an electronic device according to an embodiment. An electronic device 2000 in FIG. 13 may include a portable terminal.

The encoder 2210 and the decoder 2110 of FIG. 13 may correspond to the encoder 120 and the decoder 230 of FIGS. 1-11.

Referring to FIG. 13, the electronic device 2000 may include an application processor 2100, a camera module 2200, working memory 2300, storage 2400, a display device 2600, a user interface 2700, and a wireless transceiver unit 2500.

The application processor 2100 may be implemented as a system-on-a-chip (SoC) that controls the overall operation of the electronic device 2000 and drives an application program, an OS, and the like. The application processor 2100 may provide the image data provided from the camera module 2200 to the display device 2600 or may store the image data in the storage 2400.

The image sensor module 100 described with reference to FIGS. 1-12 may be applied to the camera module 2200. An image sensor included in the camera module 2200 may include an encoder 2210, and the encoder 2210 may compress image data to generate compressed data and transmit the compressed data to the application processor 2100. As described above, the encoder 2210 according to an embodiment may generate first image data and second image data based on the image data, may compress the first image data to generate partial compressed data, and may pack the second image data into the partial compressed data to generate a plurality of bitstreams (e.g., data streams obtained by compressing the image data).

The application processor 2100 may include the decoder 2110 that decompresses the compressed data, according to the decoding method corresponding to the compression method of the encoder 2210, e.g., the encoding method. The decoder 2110 may decompress the compressed data received from the camera module 2200 to generate restored image data and the application processor 2100 may image-process the restored image data.

The decoder 2110 according to an embodiment may separate the plurality of bitstreams to generate partial compressed data and remaining compressed data according to the at least one decoding method, decompress the partial compressed data to generate partial decompressed data, and pack the partial decompressed data, the portion of the remaining compressed data, and the random data, according to the at least one decoding method, to retore (e.g., decompress) the image data.

The application processor 2100 may display the restored image data or the image-processed image data on the display device 2600 or store the restored or image-processed data in the storage 2400.

The working memory 2300 may be implemented as volatile memory, such as DRAM or SRAM, or nonvolatile resistive memory, such as FeRAM, RRAM, or PRAM. The working memory 2300 may store programs and/or data processed and executed by the application processor 2100.

The storage 2400 may be implemented as a nonvolatile memory device, such as NADN flash, resistive memory and the like. For example, the storage 2400 may be provided as a memory card (MMC, eMMC, SD, and micro SD). The storage 2400 may store image data received from the camera module 2200 or data processed or generated by the application processor 2100.

The user interface 2700 may be implemented as various devices capable of receiving a user input, such as a keyboard, a curtain key panel, a touch panel, a fingerprint sensor, and a microphone. The user interface 2700 may receive a user input and provide a signal corresponding to the received user input to the application processor 2100.

The wireless transceiver unit 2500 may include a transceiver 2510, a modem 2520, and an antenna 2530.

While some embodiments are particularly shown and described herein, it will be understood that various changes in form and details may be made therein without departing from the spirit and scope of the following claims.

What is claimed is:

1. An encoder for compressing image data generated by an image sensor, the encoder comprising:
a bit-depth control circuit configured to:
generate first image data based on a first plurality of bits extracted from the image data according to at least one encoding scheme, and
generate second image data, based on a second plurality of bits corresponding to remaining image data different from the first image data from among the image data;
an encoding circuit configured to compress the first image data to generate partial compressed data;
a register configured to store the second image data; and
a packing circuit configured to:
pack the second image data into the partial compressed data to generate compressed data, and
output the compressed data.

2. The encoder of claim 1, wherein the bit-depth control circuit is further configured to:
extract a first plurality of most significant bits (MSBs) from the image data according to a first encoding scheme from among the at least one encoding scheme, and set the first plurality of MSBs as the first image data, wherein a number of the first plurality of MSBs is a predetermined number; and
obtain a second plurality of MSBs from the remaining image data, and set the second plurality of MSBs as the second image data, according to the first encoding scheme.

3. The encoder of claim 1, wherein the bit-depth control circuit is further configured to:
extract a first plurality of least significant bits (LSBs) from the image data according to a second encoding scheme from among the at least one encoding scheme, and set the first plurality of LSBs as the first image data, wherein a number of the first plurality of LSBs is a predetermined number; and
obtain a second plurality of LSBs from the remaining image data, and set the second plurality of LSBs as the second image data, according to the second encoding scheme.

4. The encoder of claim 1, wherein the bit-depth control circuit is further configured to:
obtain a first plurality of most significant bits (MSBs) from the image data, and set the first plurality of MSBs as the second image data according to a third encoding scheme from among the at least one encoding scheme; and
extract a second plurality of MSBs according to the third encoding scheme from a portion of the image data that is different from the second image data, and set the second plurality of MSBs as the first image data, wherein a number of the second plurality of MSBs is a predetermined number.

5. The encoder of claim 1, wherein the bit-depth control circuit is further configured to generate the first image data and the second image data based on a control signal received from the image sensor, and
wherein the control signal comprises information about a number of bits of the image data output from the image sensor, a compression ratio of the encoder, and a selected encoding scheme from among a plurality of encoding schemes.

6. The encoder of claim 1, wherein, to generate the compressed data, the packing circuit is further configured to output the second image data according to an output timing of the partial compressed data.

7. The encoder of claim 1, wherein the register comprises a first-in first-out (FIFO) register.

8. The encoder of claim 1, wherein the compressed data comprises a header, a payload, and the second image data, and
wherein the header comprises information about an encoding scheme for the image data and a number of quantization times associated with a compression process for the image data.

9. A decoder for decompressing compressed data, the decoder comprising:
a bit-depth control circuit configured to separate the compressed data into partial compressed data and remaining compressed data according to at least one decoding scheme;
a register configured to store the remaining compressed data;
a decoding circuit configured to decompress the partial compressed data to generate partial decompressed data; and
a dithering circuit configured to:
generate random data,
pack a portion of the remaining compressed data into the partial decompressed data, based on the at least one decoding scheme, to generate packing data, and
pack the random data into the packing data to generate decompressed data.

10. The decoder of claim 9, wherein the dithering circuit is further configured to:
generate the packing data according to a first decoding scheme among the at least one decoding scheme, such that the partial decompressed data is included in a most significant bit (MSB) of the packing data, and the portion of the remaining compressed data is included in a least significant bit (LSB) of the packing data; and
generate the decompressed data according to the first decoding scheme, such that the packing data is included in an MSB of the decompressed data, and the random data is included in an LSB of the decompressed data.

11. The decoder of claim 9, wherein the dithering circuit is further configured to:
generate the packing data according to a second decoding scheme among the at least one decoding scheme, such that the portion of the remaining compressed data is included in a most significant bit (MSB) of the packing data and the partial decompressed data is included in a least significant bit (LSB) of the packing data; and
generate the decompressed data according to the second decoding scheme, such that the random data is included in an MSB of the decompressed data, and the packing data is included in an LSB of the decompressed data.

12. The decoder of claim 9, wherein the dithering circuit is further configured to:
generate the packing data according to a third decoding scheme among the at least one decoding scheme, such that the portion of the remaining compressed data is included in a most significant bit (MSB) of the packing data, and the partial decompressed data is included in a least significant bit (LSB) of the packing data; and
generate the decompressed data according to the third decoding scheme, such that the packing data is included in an MSB of the decompressed data and the random data is included in an LSB of the decompressed data.

13. The decoder of claim 9, wherein the dithering circuit comprises a random number generator, and
wherein the dithering circuit is further configured to generate the random data based on the random number generator.

14. The decoder of claim 9, wherein the register comprises a first-in first-out (FIFO) register.

15. The decoder of claim 9, wherein the compressed data comprises a header, a payload, and the remaining compressed data, and
wherein the header comprises information about an encoding scheme for image data and a number of quantization times associated with a compression process for the image data.

16. The decoder of claim 15, wherein the at least one decoding scheme is determined based on the header of the compressed data.

17. An image processing system comprising:
an image sensor configured to sense a received optical signal in order to generate image data;
an encoder configured to sequentially compress a plurality of pixel groups included in the image data to generate a plurality of bitstreams; and
a decoder configured to decompress the plurality of bitstreams to restore the image data, wherein the encoder is further configured to:
generate first image data and second image data, based on the image data, according to at least one encoding scheme;
compress the first image data to generate partial compressed data; and
pack the second image data into the partial compressed data to generate the plurality of bitstreams.

18. The image processing system of claim 17, wherein the encoder is further configured to operate according to one from among a first encoding scheme, a second encoding scheme, and a third encoding scheme,
wherein, according to the first encoding scheme, the first image data is generated by extracting a predetermined number of most significant bits (MSBs) from the image data, and MSBs of remaining image data are set as the second image data;
wherein, according to the second encoding scheme, the first image data by extracting a predetermined number of least significant bits (LSBs) from the image data, and LSBs of remaining image data are set as the second image data; and
wherein, according to the third encoding scheme, MSBs of the image data are set as the second image data, and the first image data is generated by extracting the predetermined number of MSBs from remaining image data.

19. The image processing system of claim 17, wherein the decoder is further configured to:
generate the partial compressed data and the second image data from the plurality of bitstreams, based on at least one decoding scheme;
decompress the partial compressed data to recover the first image data; and
based on the at least one decoding scheme, restore the image data by packing the recovered first image data, the second image data, and random data.

20. The image processing system of claim 19, wherein the decoder further comprises a random number generator, and
wherein the decoder is further configured to generate the random data based on the random number generator.
